(19) United States
(12) Patent Application Publication
(10) Pub. No.: US 2021/0122018 A1
(43) Pub. Date: Apr. 29, 2021

(54) DRIVING TOOL

(71) Applicant: KOKI HOLDINGS CO., LTD., Tokyo (JP)

(72) Inventors: Sotaro AIZAWA, Ibaraki (JP); Kazuhiro OOTSUKA, Ibaraki (JP)

(73) Assignee: Koki Holdings Co., Ltd., Tokyo (JP)

(21) Appl. No.: 17/040,177

(22) PCT Filed: Feb. 22, 2019
(86) PCT No.: PCT/JP2019/006742

§ 371 Date: Sep. 22, 2020

(30) Foreign Application Priority Data
Mar. 29, 2018 (JP) 2018-064700
Mar. 30, 2018 (JP) 2018-069258

(51) Int. Cl. B25C 1/04; B25C 1/06

(52) U.S. Cl. CPC B25C 1/047; B25C 7/00; B25C 1/043; B25C 1/06

(57) ABSTRACT

A driving tool capable of moving a striking unit in a direction of striking a fastener when electric power supply to a switching mechanism stops is provided. Further, a driving tool capable of setting a timing of generating a function of preventing moving force transfer from a contact member to a gas supply mechanism is provided. A driving tool including an operational member, a contact member, a pressure chamber, a striking unit and a driving unit has a first mode and a second mode that can be selected by an operator. When the second mode is selected, if a state with the operator operating the operational member and with the contact member being away from the workpiece is within predetermined time, movement of the contact member is not prevented. When the second mode is selected, if the state with the operator operating the operational member and with the contact member being away from the workpiece exceeds the predetermined time, the movement of the contact member is prevented.

### TECHNICAL FIELD

The present invention relates to a driving tool including a striking unit moved by a pressure of compressed gas.

### BACKGROUND ART

A one example of a driving tool including a pressure chamber to which compressed gas is supplied and a striking unit moved by a pressure of the compressed gas supplied to the pressure chamber is described in a Patent Document 1. The driving tool described in the Patent Document 1 includes: the striking unit; a piston upper chamber; a main valve chamber; a cylinder; a pressure accumulating chamber; a trigger worked as an operational member; a push lever worked as a contact member; and a switching knob. In the driving tool described in the Patent Document 1, when an operational force is applied onto the trigger while the push lever is pressed against a workpiece, the compressed gas of the pressure accumulating chamber is supplied to the main valve chamber. The cylinder is moved by a pressure of the main valve chamber, and the compressed gas of the pressure accumulating chamber is supplied to the piston upper chamber, so that the striking unit moves from a top dead center to a bottom dead center.

In the driving tool described in the Patent Document 1, an operator can perform switching between a first mode and a second mode by operating the switching knob. When the first mode is selected, the push lever is pressed against the workpiece first, and then, the operational force is applied onto the trigger. When the second mode is selected, the push lever is pressed against the workpiece while the operational force is applied onto the trigger.

### RELATED ART DOCUMENT

### Patent Document

Patent Document 1: Japanese Patent Application Laid-Open Publication No. 2012-115922

### SUMMARY OF THE INVENTION

### Problems to be Solved by the Invention

The inventors of the present application have studied a driving tool capable of preventing the movement of the striking unit when the second mode is selected. The driving tool studied by the inventors of the present application has a first state in which the striking unit can be moved by the pressing of the contact member against the workpiece when elapsed time from the application of the operational force to the operational member is within predetermined time, and a second state in which the striking unit is not moved even by the pressing of the contact member against the workpiece when the elapsed time from the application of the operational force to the operational member exceeds the predetermined time.

Further, the inventors of the present application have studied to provide the driving tool with a switching mechanism switching the first state and the second state and being moved by electric power. Accordingly, the inventors of the present application have found that the striking unit of the driving tool possibly does not move when the supply of the electric power to the switching mechanism stops. Further, the inventors have also found a problem that possibly makes the operator feel uncomfortable if a timing of generating a function cannot be set, the function preventing movement-power transfer from the contact member to a gas supply mechanism.

A purpose of the present invention is to provide a driving tool capable of moving the striking unit in a direction in which a fastener is struck, when the supply of the electric power to the switching mechanism stops. Further, another purpose of the present invention is to provide a driving tool capable of setting the timing of generating the function preventing the movement-power transfer from the contact member to the gas supply mechanism.

### Means for Solving the Problems

A driving tool includes: an operational member configured to apply an operational force by an operator; a contact member allowed to be in contact with and away from a workpiece and moving in contact with the workpiece; a switching mechanism allowed to switch a first state in which movement of the contact member is transferred and a second state in which the transfer of the movement of the contact member is prevented; a striking unit configured to strike a fastener; and a mode selecting member allowed to be operated by the operator and configured to control driving of the striking unit. The mode selecting member has a first mode in which the operator operates the operational member while moving the contact member and a second mode based on the movement of the contact member and the operation for the operational member regardless of an order of the movement of the contact member and the operation for the operational member. When the second mode is selected and when a state with the operational member being operated by the operator and with the contact member being away from the workpiece is within predetermined time, the electric power is supplied to the switching mechanism so that the switching mechanism becomes in the first state. When the second mode is selected and when the state with the operational member being operated by the operator and with the contact member being away from the workpiece exceeds the predetermined time, the supply of the electric power to the switching mechanism stops so that the switching mechanism becomes in the second state.

### Effects of the Invention

A driving tool of an embodiment can move the striking unit in the direction in which the fastener is struck when the first mode is selected in the case of the stoppage of the electric power supply to the switching mechanism.

Further, in cooperation with the application of the operational force to the operational member by the operator, a prevention member inhibits the moving force of the contact member from transferring to the gas supply mechanism.

### BRIEF DESCRIPTIONS OF THE DRAWINGS

FIG. 1A is a side view showing a first embodiment of a driving tool included in the present invention;

FIG. 1B is a partial cross-sectional view of the driving tool shown in FIG. 1A;

FIG. 2 is a partial side view showing a state with selection of a first mode in the driving tool shown in FIG. 1A;

FIG. 3 is a partial side view showing a state with selection of a second mode in the driving tool shown in FIG. 1A and a state of disabling a push lever to move;

FIG. 4 is a partial side view showing the state with the selection of the second mode in the driving tool shown in FIG. 1A and a state of enabling the push lever to move;

FIG. 5 is a block diagram showing a control system of the driving tool;

FIG. 6 is a partial side view showing a state with selection of the first mode in a second embodiment of the driving tool;

FIG. 7 is a partial side view showing the state with the selection of the second mode in the second embodiment of the driving tool and a state of disabling a push lever to move;

FIG. 8 is a partial side view showing the state with the selection of the second mode in the second embodiment of the driving tool and a state of enabling the push lever to move;

FIG. 9 is a partial side view showing a state with selection of the first mode in a third embodiment of the driving tool;

FIG. 10 is a partial side view showing a state with selection of the second mode in the third embodiment of the driving tool and a state of disabling a push lever to move;

FIG. 11 is a partial side view showing the state with the selection of the second mode in the third embodiment of the driving tool and a state of enabling the push lever to move;

FIG. 12 is a partial side view showing a state with selection of the first mode in a fourth embodiment of the driving tool;

FIG. 13 is a planar cross-sectional view of a rotary solenoid on a line E1-E1 of FIG. 12;

FIG. 14 is a partial cross-sectional view on a line E2-E2 of FIG. 12;

FIG. 15 is a partial side view showing a state with selection of the second mode in the fourth embodiment of the driving tool and a state with stoppage of electric power supply to the rotary solenoid;

FIG. 16 is a planar cross-sectional view of a rotary solenoid on a line E1-E1 of FIG. 15;

FIG. 17 is a partial cross-sectional view on a line E2-E2 of FIG. 15;

FIG. 18 is a partial side view showing the state with selection of the second mode in the fourth embodiment of the driving tool and a state with the electric power supply to the rotary solenoid;

FIG. 19 is a planar cross-sectional view of a rotary solenoid on a line E1-E1 of FIG. 18;

FIG. 20 is a flowchart including a first control example of the driving tool;

FIG. 21 is a schematic view showing another example of the push lever arranged in the driving tool;

FIG. 22 is a vertical cross-sectional view showing a fifth embodiment of the driving tool;

FIG. 23 is a cross-sectional view showing a trigger and a prevention mechanism arranged in the driving tool of FIG. 1, the trigger and the prevention mechanism being in an initial state;

FIG. 24 is a block diagram showing a control system of the driving tool of FIG. 1;

FIG. 25 is a cross-sectional view showing a moving state of the trigger and the initial state of the prevention mechanism;

FIG. 26 is a cross-sectional view showing the moving state of the trigger and a moving state of the prevention mechanism;

FIG. 27 is a cross-sectional view showing the moving state of the trigger, the initial state of the prevention mechanism, and a moving state of a trigger valve;

FIG. 28 is a flowchart showing a second control example that can be performed by a controller arranged in the driving tool;

FIG. 29 is a flowchart showing a third control example that can be performed by the controller arranged in the driving tool;

FIG. 30 is a partial cross-sectional view showing a sixth embodiment of the driving tool;

FIG. 31 is a front cross-sectional view showing the trigger and the push lever at an initial position in the second mode in a seventh embodiment of the driving tool;

FIG. 32 is a planar cross-sectional view showing a case of the selection of the first mode in the seventh embodiment of the driving tool;

FIG. 33 is a planar cross-sectional view showing a case of the selection of the second mode in the seventh embodiment of the driving tool;

FIG. 34 is a front cross-sectional view showing the trigger and the push lever at an operational position in the second mode in the seventh embodiment of the driving tool;

FIG. 35 is a front cross-sectional view showing the trigger and the push lever at the initial position in the first mode in the seventh embodiment of the driving tool;

FIG. 36 is a flowchart showing a fourth control example that can be performed in the seventh embodiment of the driving tool;

FIG. 37 is a flowchart showing a fifth control example that can be performed in the seventh embodiment of the driving tool; and

FIG. 38 is a partial cross-sectional view showing an eighth embodiment of the driving tool.

### BEST MODE FOR CARRYING OUT THE INVENTION

Next, a typical driving tool of some embodiments included in the driving tool of the present invention will be explained with reference to the drawings.

### First Embodiment

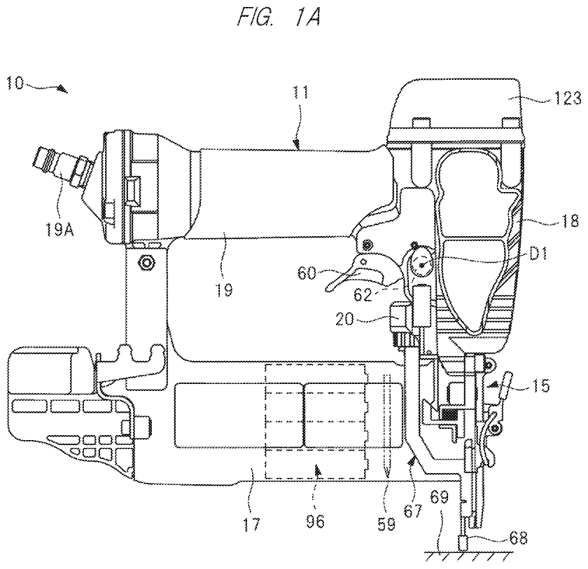

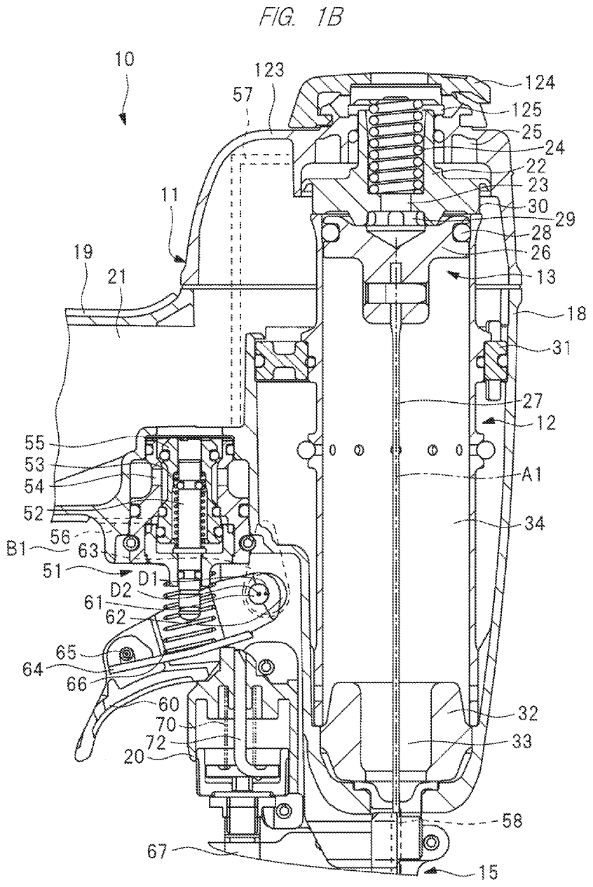

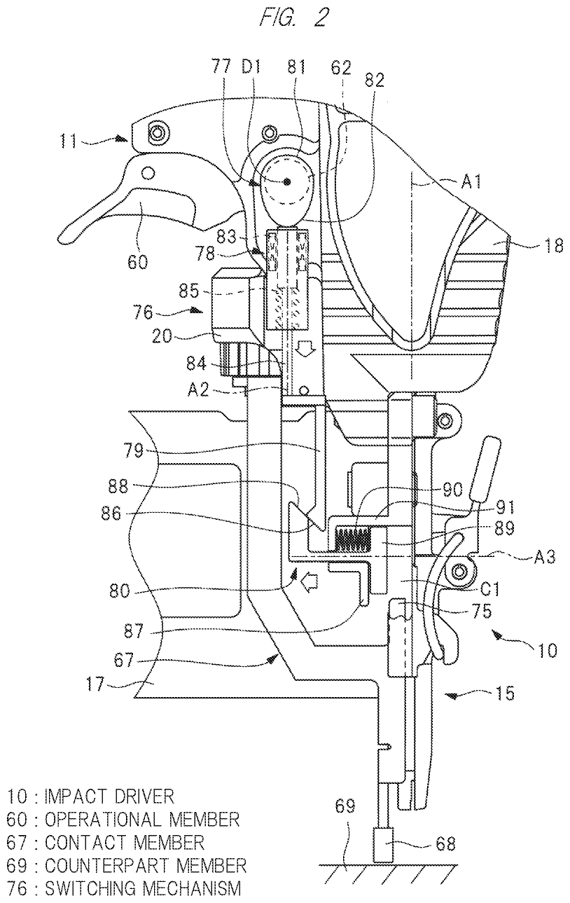

A first embodiment of the driving tool will be explained with reference to FIGS. 1A, 1B and 2. A driving tool 10 includes a main body 11, a cylinder 12, a striking unit 13, a trigger 60, an injection unit 15 and a push lever 67. A magazine 17 is attached to the driving tool 10. The main body 11 includes a tubular body portion 18, a handle 19 connected to the body portion 18, an exhaust cover 123 fixed to the body portion 18, and a holder 20 protruding from an outer surface of the body portion 18. The handle 19 protrudes from the outer surface of the body portion 18.

As shown in FIG. 1B, a pressure accumulating chamber 21 is formed over inside of the handle 19, inside of the body portion 18 and inside the exhaust cover 123. As shown in FIG. 1A, a plug 19A is attached to the handle 19, and an air hose is connected to the plug 19A. The compressed air serving as the compressed gas is supplied from the plug 19A into the pressure accumulating chamber 21. The cylinder 12 is arranged inside the body portion 18.

A head valve 22 is arranged inside the exhaust cover 123. The head valve 22 is movable in a direction of a centerline A1 of the cylinder 12. The head valve 22 includes a gas-exhaust path 23. An urging member 24 is arranged inside the exhaust cover 123, and the urging member 24 urges the head valve 22 so that the head valve goes close to the cylinder 12 in the direction of the centerline A1. One example of the urging member 24 is a metallic spring. A control chamber 25 is arranged inside the exhaust cover 123. To/from the control chamber 25, the compressed gas is supplied/exhausted. The head valve 22 is urged by a pressure of the control chamber 25 so as to go close to the cylinder 12 in the direction of the centerline A1. Further, the head valve 22 is urged by a pressure of the pressure accumulating chamber 21 so as to go away from the cylinder 12 in the direction of the centerline A1. To the exhaust cover 123, a top cover 124 is attached. An exhaust port 125 is formed between the head valve 22 and the top cover 124. The exhaust port 125 communicates with the exhaust path 23. When the head valve 22 moves in the direction of the centerline A1, the exhaust port 125 opens or closes. When the exhaust port 125 opens, a piston upper chamber 29 and an outer portion B1 are connected to each other. When the exhaust port 125 closes, the piston upper chamber 29 and the outer portion B1 are disconnected from each other.

The cylinder 12 is arranged over a portion from inside of the body portion 18 to inside of the exhaust cover 123. An annular holder 31 is arranged inside the body portion 18, and the holder 31 supports the cylinder 12. The cylinder 12 is positioned with respect to the body portion 18 in the direction of the centerline A1.

The striking unit 13 includes a piston 26 and a driver blade 27 fixed to the piston 26. The piston 26 is arranged inside the cylinder 12, and the piston 26 is movable in the direction of the centerline A1. A sealing member 28 is attached to an outer circumferential surface of the piston 26. The piston upper chamber 29 is formed between the head valve 22 and the piston 26. The piston upper chamber 29 communicates with the gas-exhaust path 23.

A port 30 is formed between the head valve 22 and the cylinder 12. When the head valve 22 is pressed against the cylinder 12 as shown in FIG. 1B, the head valve 22 closes the port 30. That is, the pressure accumulating chamber 21 and the piston upper chamber 29 are disconnected from each other. And, the piston upper chamber 29 communicates with the outer portion B1 through the gas-exhaust path 23. When the head valve 22 goes away from the cylinder 12, the head valve 22 opens the port 30. That is, the pressure accumulating chamber 21 and the piston upper chamber 29 are connected to each other.

As shown in FIG. 1B, a bumper 32 is arranged inside the body portion 18. The body portion 18 is arranged between the exhaust cover 123 and the injection unit 15 in the direction of the centerline A1. The bumper 32 is arranged inside the body portion 18. A part of the bumper 32 is arranged inside the cylinder 12. The bumper 32 is arranged at a position that is the closest to the injection unit 15 in the direction of the centerline A1. The bumper 32 is made of a synthetic rubber or a silicon rubber. The bumper 32 includes a shaft hole 33, and the driver blade 27 is movable inside the shaft hole 33 in the direction of the centerline A1. Inside the cylinder 12, a piston lower chamber 34 is formed between the piston 26 and the bumper 32. The sealing member 28 air-tightly disconnects the piston lower chamber 34 from the piston upper chamber 29.

As shown in FIG. 1B, a trigger 60 is attached to the main body 11. The trigger 60 is attached to the main body 11 through a support shaft 61 and a main shaft 62. The main shaft 62 has a columnar shape, and the main shaft 62 is rotatable within a range of a predetermined angle from the main body 11 around a centerline D1 that is set as its center. The support shaft 61 is arranged so as to set a centerline D2 as its center that is eccentrically arranged from the centerline D1.

A mode selecting member 63 is attached to the main shaft 62. The mode selecting member 63 is attached to a first end of the main shaft 62 in a longitudinal direction. When an operator releases the operational force from the mode selecting member63, the main shaft 62 stops. The operator selects a mode for use in the driving tool 10 by operating the mode selecting member 63. The mode selecting member 63 has a first operational position and a second operational position. The first operational position and the second operational position are different from each other in a position in the rotational direction of the main shaft 62. The first operational position and the second operational position are different from each other by, for example, 180 degrees in the rotational direction of the main shaft 62. One example of the mode selecting member 63 is a lever or a knob. When the operator operates the mode selecting member 63, the support shaft 61 revolves around the centerline D1. The trigger 60 is rotatable around the support shaft 61 set as its center as well as being able to revolve around the centerline D1 set as its center.

As shown in FIG. 1B, an arm 64 is attached to the trigger 60. The arm 64 is movable within a range of a predetermined angle from the trigger 60 around a support shaft 65 set as its center. The support shaft 65 is arranged in the trigger 60, and the support shaft 65 is arranged at a position that is different from that of the support shaft 61. An urging member 66 is arranged for urging the arm 64 and the trigger 60. One example of the urging member 66 is a metallic compressed spring. The arm 64 is urged clockwise in FIG. 1B by the urging member 66. A free end of the arm 64 that is urged by the urging member 66 is brought in contact with the holder 20, and then, stops at an initial position.

The urging force of the urging member 66 is applied onto the trigger 60 through the arm 64 and the support shaft 65. The trigger 60 is urged counterclockwise around the support shaft 61 set as its center by the urging member 66. When the arm 64 stops at the initial position, the trigger 60 is brought in contact with the holder 20, and then, stops at the initial position.

As shown in FIG. 1B, a trigger valve 51 is arranged at a connection portion between the body portion 18 and the handle 19. The trigger valve 51 includes a plunger 52, a valve disc 55, an urging member 53, a path 54 and a gas-exhaust path 56. The plunger 52 is moved by an urging force of the urging member 53 and a moving force of the arm 64. The path 54 is connected to the control chamber 25 through a path 57.

The injection unit 15 is fixed to the body portion 18, and the injection unit 15 includes an injection path 58. The centerline A1 is positioned inside the injection path 58, and the driver blade 27 is movable inside the injection path 58 in the direction of the centerline A1. The injection unit 15 performs prevention so that the moving direction of the driver blade 27 is the direction of the centerline A1.

The magazine 17 is fixed to the injection unit 15. The magazine 17 houses a nail 59. A plurality of nails 59 are housed inside the magazine 17 so that the nails are connected to each other by a joint element. The magazine 17 includes a feeder, and the feeder feeds the nails 59 inside the magazine 17 to the injection path 58.

The push lever 67 is made of metal or non-metal. The push lever 67 is arranged so as to be able to reciprocate in the direction of the centerline A1 with respect to the injection unit 15. A contactor 68 is arranged at an end of the push lever 67. The contactor 68 can be in contact with and away from a workpiece 69. The workpiece 69 is an object into which the nail 59 is struck.

An urging member 70 is arranged, and the urging member 70 urges the push lever 67 in the direction of the centerline A1 so that the push lever goes away from the body portion 18. The urging member 70 is arranged in the holder 20 as one example. The urging member 70 is a metallic compressed spring. The injection unit 15 is provided with a positioning portion, and the push lever 67 that is urged by the urging member 70 is brought in contact with the positioning portion, and then, stops at the initial position.

A transfer member 72 is connected to the push lever 67. The transfer member 72 is arranged at an end that is opposite to the contactor 68 in the moving direction of the push lever 67. The holder 20 supports the transfer member 72 so that the transfer member is movable in the direction of the centerline A1. When the transfer member 72 is in contact with the arm 64, the moving force of the push lever 67 is transferred to the arm 64. When the transfer member 72 is away from the arm 64, the moving force of the push lever 67 is not transferred to the arm 64. The transfer member 72 is urged by the urging member 70 so as to go away from the arm 64. As shown in FIG. 2, the push lever 67 is provided with an engaging portion 75. The engaging portion 75 is arranged between the contactor 68 and the transfer member 72 in the direction of the centerline A1.

The main body 11 is provided with a switching mechanism 76. The switching mechanism 76 includes a cam 77, a solenoid 78, a moving member 79 and a stopper 80. The cam 77 is attached to the main shaft 62. An outer circumferential surface of the cam 77 curves, and the outer circumferential surface of the cam 77 has a small diameter portion 81 and a large diameter portion 82. An outer diameter of the large diameter portion 82 is larger than an outer diameter of the small diameter portion 81. Both the small diameter portion 81 and the large diameter portion 82 are arranged so as to curve and be continuous. Each of the moving member 79, the stopper 80 and the cam 77 is made of a metal as one example.

The solenoid 78 includes a coil 83, a plunger 84 and an urging member 85. The plunger 84 is made of a magnetic material such as iron. The plunger 84 is movable in a direction of a centerline A2. The centerline A2 is parallel to the centerline A1. The urging member 85 urges the plunger 84 so that the plunger goes close to the stopper 80. One example of the urging member 85 is a metallic compressed spring. The coil 83 is made of a conductive material. When an electric current flows in the coil 83, a magnetic suction force is formed. The plunger 84 is moved by the magnetic suction force so as to go close to the stopper 80.

The moving member 79 is movable in the direction of the centerline A2, and the moving member 79 is coupled to the plunger 84. An inclination surface 86 is formed in an end of the moving member 79, the end being opposite to the plunger 84. The inclination surface 86 is inclined from the centerline A2.

The stopper 80 is movable in a direction of a centerline A3. The centerline A3 crosses the centerlines A1 and A2. FIG. 2 shows an example in which the centerline A3 crosses the centerlines A1 and A2 at an angle of 90 degrees. The injection unit 15 is provided with a guide portion 87, and the guide portion 87 guides the movement of the stopper 80. The guide portion 87 prevents a range of the movement of the stopper 80 in the direction of the centerline A3. The guide portion 87 prevents the stopper 80 from moving in the direction of the centerline A1. An inclination surface 88 is formed in the stopper 80. The inclination surface 88 is parallel to the inclination surface 86. When the inclination surface 88 and the inclination surface 86 are in contact with each other, the moving force is applied from the moving member 79 to the stopper 80 in the direction of the centerline A3. The stopper 80 is provided with an engaging portion 89.

An urging member 90 is arranged, and the urging member 90 urges the stopper 80 in the direction of the centerline A3. One example of the urging member 90 is a metallic compressed spring. A wall 91 is formed in the injection unit 15. The wall 91 is arranged between the engaging portion 75 and the body portion 18 in the direction of the centerline A1.

When the stopper 80 moves, the engaging portion 89 is movable in and out of a moving range of the engaging portion 75. That is, the engaging portion 89 can go into and out of a gap C1 between the engaging portion 75 and the wall 91. An urging member 90 urges the stopper 80 so that the engaging portion 89 goes into the gap C1.

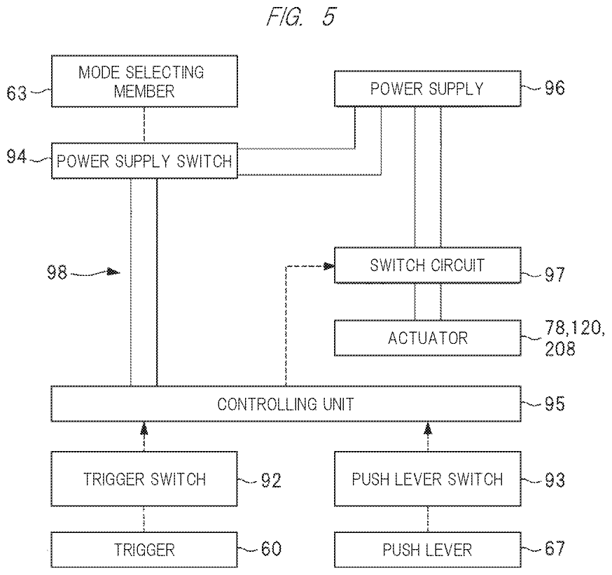

FIG. 5 is a block diagram showing a control system of the driving tool 10. The driving tool 10 includes a trigger switch 92, a push lever switch 93, a power supply switch 94, a control unit 95, a power supply 96, a switch circuit 97 and a solenoid 78. The solenoid 78 is one example of an actuator 120. The power supply 96 is formed so that a battery cell is housed in a case. As the battery cell, a secondary battery that can be repeatedly charged and discharged can be used. Note that the battery cell may be a primary battery. The power supply 96 can be arranged so as to be detachable to an outer surface of the magazine 17 as one example.

The power supply 96 is connected to the solenoid 78 through the switch circuit 97. The power supply switch 94 is arranged in an electric circuit 98 between the power supply 96 and the control unit 95. The power supply switch 94 is turned ON or OFF in accordance with an operational position of the mode selecting member.

The control unit 95 is a microcomputer including an input interface, an output interface, a storage unit, a computation processing unit and a timer. A signal of the trigger switch 92 and a signal of the push lever switch 93 are input to the control unit 95.

Next, an intended use of the driving tool 10 will be explained. First, the operator selects the first mode or the second mode by operating the mode selecting member 63 while grasping the handle 19. The first mode is selected at the time of the movement of the striking unit 13 when the operator applies the operational force onto the trigger 60 using his/her finger while the contactor 68 of the push lever 67 is pressed against the workpiece 69. The second mode is selected at the time of the movement of the striking unit 13 when the operator presses the contactor 68 against the workpiece 69 while the operational force is applied onto the trigger 60. A first operational position corresponds to the first mode, and a second operational position corresponds to the second mode.

The support shaft 61 is eccentrically arranged from the main shaft 62. Therefore, a positional relation between the transfer member 72 and the arm 64 is changed by the mode that is selected by the operator.

(Example of Selection of First Mode by Operator)

An example of selection of the first mode resulted from the operation of the mode selecting member 63 by the operator will be explained. When the operator selects the first mode, the power supply switch 94 is turned OFF, so that the electric power of the power supply 96 is not supplied to the control unit 95. That is, the control unit 95 stops. The electric power of the power supply 96 is not supplied to the solenoid 78. Further, when the first mode is selected, the large diameter portion 82 of the cam 77 pushes the plunger 84 as shown in FIG. 2, and the plunger 84 is moved against the urging force of the urging member 85, so that the plunger 84 stops at the operational position shown in FIG. 2. The moving member 79 stops at the operational position in the direction of the centerline A2.

The operational position of the operational member 79 is a position at which the operational member 79 is the farthest from the solenoid 78 in the direction of the centerline A2. The stopper 80 is urged by a reactive force caused when the inclination surface 86 and the inclination surface 88 are in contact with each other, so that the engaging portion 89 goes out of the space C1. Further, the engaging portion 89 is in contact with the guiding portion 87, so that the stopper 80 stops.

In the state of the selection of the first mode, when the operational force onto the trigger 60 is released while the contactor 68 is away from the workpiece 69, the trigger valve 51, the head valve 22 and the striking unit 13 of the driving tool 10 are in the following initial state.

The plunger 52 of the trigger valve 51 stops at the initial position. Therefore, the pressure accumulating chamber 21 and the path 54 are connected to each other, and the path 54 and the gas-exhaust path 56 are disconnected from each other. That is, the trigger valve 51 is in the initial state.

When the trigger valve 51 is in the initial state, the compressed air of the pressure accumulating chamber 21 is supplied to the control chamber 25 through the path 57. The head valve 22 is pressed against the cylinder 12 by the urging force of the urging member 24 so that the head valve 22 closes the port 30. The piston upper chamber 29 is connected to outside B1 through the exhaust port 125. Therefore, the piston 26 stops while being pressed against the head valve 22 by a pressure of the piston lower chamber 34. In this manner, the striking unit 13 stops at a top dead center.

Next, the operator presses the contactor 68 of the push lever 67 against the workpiece 69. As shown in FIG. 2, the engaging portion 89 is positioned out of the space C1. Therefore, the push lever 67 is movable, and the moving force of the push lever 67 is transferred to the transfer member 72. Although the arm 49 is moved by the moving force of the transfer member 72, the plunger 52 is not moved at this stage, and the plunger 52 stops at the initial position.

When the operator applies the operational force onto the trigger 60 in the state with the pressing of the contactor 68 against the workpiece 69, the moving force of the arm 64 is transferred to the plunger 52, and the plunger 52 moves from the initial position, and then, stops at the operational position. When the plunger 52 stops at the operational position, the gas-exhaust path 56 and the path 54 are connected to each other while the pressure accumulating chamber 21 and the path 54 are disconnected from each other. The state with the connection between the gas-exhaust path 56 and the path 54 and with the disconnection between the pressure accumulating chamber 21 and the path 54 is the moving state of the trigger valve 51.

When the trigger valve 51 is in the moving state, the compressed air of the control chamber 25 is exhausted to the outside B1 through the path 57 and the gas-exhaust path 56 so that a pressure of the control chamber 25 is the same as the atmospheric pressure.

When the pressure of the control chamber 25 is the same as the atmospheric pressure, the head valve 22 is moved against the urging force of the urging member 24 by the pressure of the pressure accumulating chamber 21. In other words, the head valve 22 disconnects the piston upper chamber 29 from the outside B1, and opens the port 30. Therefore, the compressed air of the pressure accumulating chamber 21 is supplied to the piston upper chamber 29 through the port 30. Thus, the striking unit 13 moves from the top dead center to a bottom dead center in the direction of the centerline A1 so that the driver blade 27 strikes the nail 59 that is inside the injection unit 58.

After the striking unit 13 strikes the nail 59, the piston 26 collides with a bumper 32, and the bumper 32 absorbs a part of kinetic energy of the striking unit 13. A position of the striking unit 13 at which the piston 26 collides with the bumper 32 is the bottom dead center.

When the operator brings the edge away from the workpiece 69 or releases the operational force on the trigger 60, a state of the trigger valve 51 is switched from the moving state to the initial state. Then, the head valve 22 is moved by the urging force of the urging member 24 to connect the piston upper chamber 29 and the outside B1, and close the port 30. Therefore, a pressure of the piston upper chamber 29 becomes the atmospheric pressure, the striking unit 13 is moved from the bottom dead center to the top dead center by the pressure of the piston lower chamber 34, and the piston 26 is brought into contact with the head valve 22 and stops at the top dead center.

Note that the arm 64 stops within the moving range of the transfer member 72 when the operational force is applied onto the trigger 60 in the state with the selection of the first mode by the operator and with the contactor 68 being away from the workpiece 69. Therefore, even when the contactor 68 is pressed against the workpiece 69 to move the push lever 67, the moving force of the transfer member 72 is not transferred to the plunger 52. Therefore, the trigger valve 51 is maintained in the initial state, and the striking unit 13 stops at the top dead center.

(Example of Selection of Second Mode by Operator)

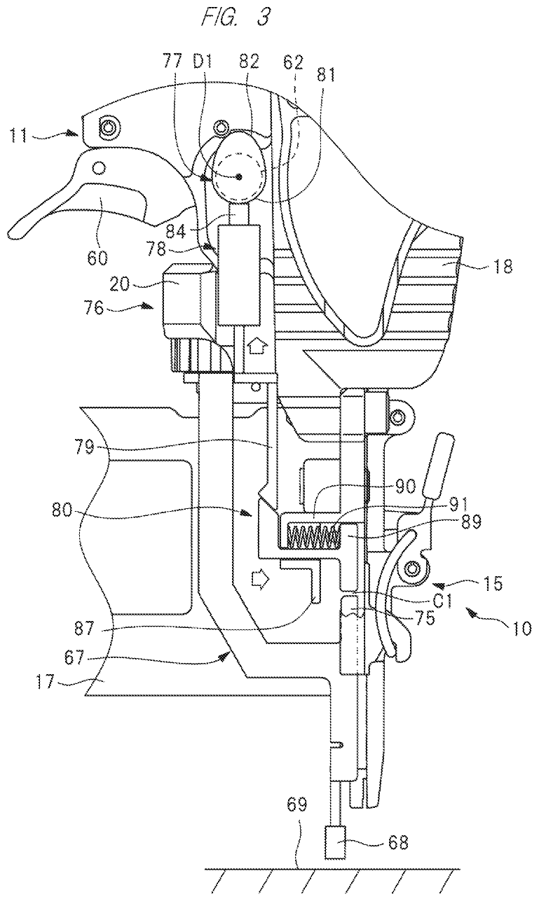

When the operator selects the second mode by operating the mode selecting member 63, the large diameter portion 82 of the cam 77 is away from the plunger 84 as shown in FIG. 3. Also, the power supply switch 94 is turned ON, the electric power of the power supply 96 is supplied to the control unit 95, and the control unit 95 is activated. The control unit 95 stops supplying the electric power to the solenoid 78 when the operational force is not applied onto the trigger 60 while the contactor 68 is away from the workpiece 69.

Therefore, as shown in FIG. 3, the plunger 84 is in contact with the small diameter portion 81 of the cam 77, and the plunger 84 stops at the initial position. When the plunger 84 stops at the initial position, the operational member 79 stops at the operational position that is the closest to the solenoid 78. When the operational member 79 stops at the operational position, the engaging unit 89 is positioned at the space C1, and the stopper 80 stops.

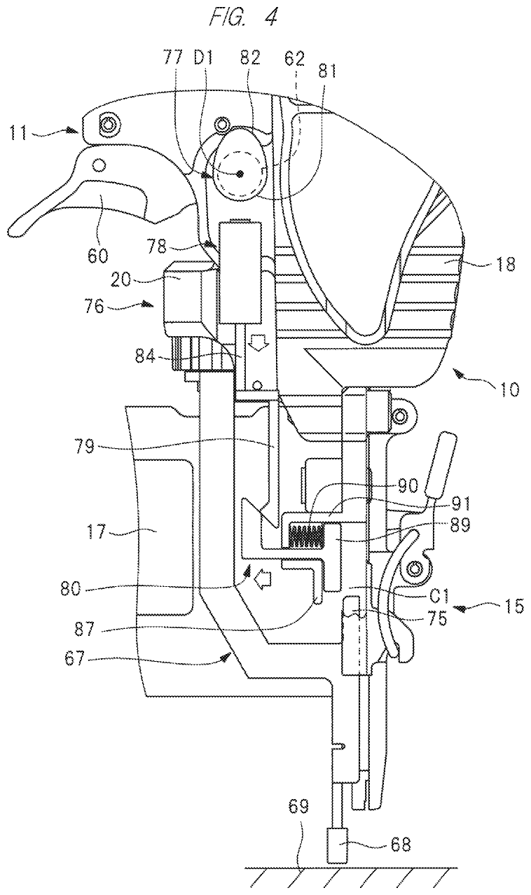

Then, the operator applies the operational force onto the trigger 60 in the state with the contactor 68 being away from the workpiece 69. Accordingly, the control unit 95 supplies the electric power of the power supply 96 to the solenoid 78, so that the plunger 84 is moved from the initial position shown in FIG. 3 to the operational position shown in FIG. 4, and then, stops. In other words, the control unit 95 continues to control the supply of the electric power to the solenoid 78. Therefore, the engaging unit 89 is positioned out of the space C1, and the stopper 80 stops. The control unit 95 counts elapsed time from a moment of the application of the operational force onto the trigger 60.

Further, when the counted elapsed time is within predetermined time, the control unit 95 continues to supply the electric power to the solenoid 78. Therefore, when the edge is pressed against the workpiece 69, the push lever 67 is movable. The moving force of the push lever 67 is transferred to the plunger 52 of the trigger valve 51, so that the trigger valve 51 is in the moving state. Therefore, the striking unit 13 moves from the top dead center to the bottom dead center. When the counted elapsed time is within predetermined time, if the edge is pressed against the workpiece 69, the control unit 95 resets the counted elapsed time.

On the other hand, when the counted elapsed time exceeds the predetermined time, the control unit 95 stops supplying the electric power to the solenoid 78. Therefore, the plunger 84 returns from the operational position to the initial position shown in FIG. 3, and then, stops. Then, when the edge is pressed against the workpiece 69, the stopper 80 blocks the movement of the push lever 67. Therefore, the push lever 67 does not move, and the trigger valve 51 is maintained in the initial state. In other words, the striking unit 13 stops at the top dead center.

When the operator releases the operational power on the trigger 60 after the counted elapsed time exceeds the predetermined time, the control unit 95 resets the counted elapsed time.

In the first embodiment of the driving tool 10, when the electric power cannot be supplied to the solenoid 78, if the operator selects the first mode by operating the mode selecting member 63, the engaging unit 89 is positioned out of the space C1. Therefore, the moving force of the push lever 67 can be transferred to the plunger 52 of the trigger valve 51, and the striking unit 13 can be moved from the top dead center toward the bottom dead center.

When the contactor 68 is pressed against the workpiece 69 in the state with the engaging unit 89 being positioned at the space C1 as shown in FIG. 3, the movement of the push lever 67 is blocked, and the reactive force caused by the pressing of the contactor 68 against the workpiece 69 is transferred to a wall 91 through the stopper 80. Therefore, a load on the stopper 80 can be reduced.

When the operator rotates the cam 77 by operating the mode selecting member in the state with the plunger 84 being in contact with the cam 77, the plunger 84 moves in the direction of the centerline A2 along a shape of the cam 77.

### Second Embodiment

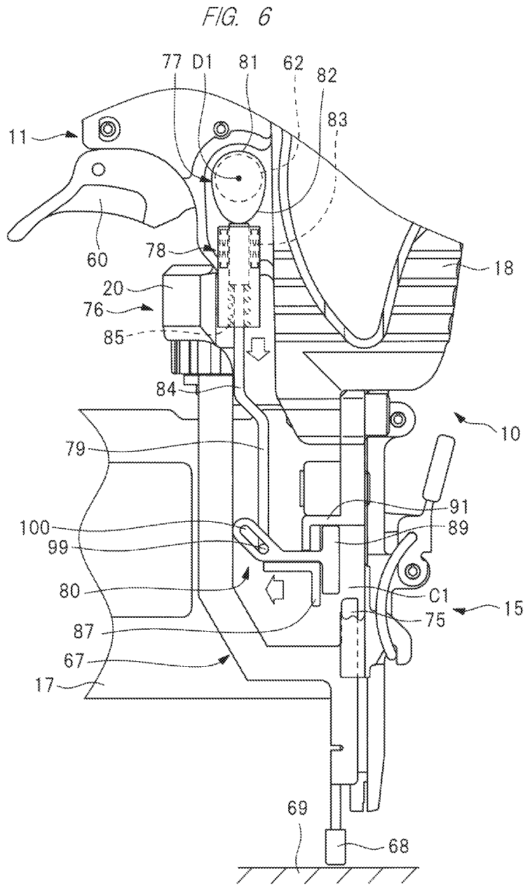

A second embodiment of the driving tool 10 is shown in FIGS. 6, 7 and 8. The first embodiment of the driving tool 10 and the second embodiment of the driving tool 10 are different from each other in a configuration of the switching mechanism 76. The plunger 84 and the moving member 79 are made of a single member. In other words, the plunger 84 and the moving member 79 are unified. The moving member 79 has a pin 99. The stopper 80 has a guide hole 100. The guide hole 100 is a long hole. The guide hole 100 is arranged to incline from the centerline A2. The pin 99 is arranged in the guide hole 100, and the pin 99 is movable in a longitudinal direction of the guide hole 100. Note that the urging member shown in FIG. 2 is not included.

(Example of Selection of First Mode by Operator)

In the second embodiment of the driving tool 10, when the operator selects the first mode, the larger diameter portion 82 of the cam 77 is pressed against the plunger 84 as shown in FIG. 6, and the plunger 84 stops at the operational position. Therefore, the engaging unit 89 is positioned out of the space C1, and the stopper 80 stops. Thus, when the operator presses the contactor 68 against the workpiece 69 while applying the operational force onto the trigger 60, the state of the trigger valve 51 shown in FIG. 1B is switched from the initial state to the moving state, and the striking unit 13 moves from the top dead center to the bottom dead center.

(Example of Selection of Second Mode by Operator)

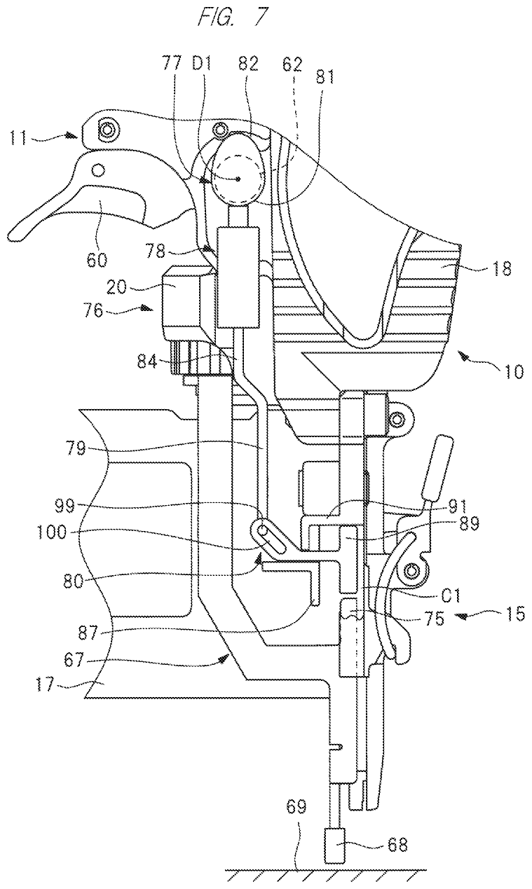

In the second embodiment of the driving tool, when the operator selects the second mode while not applying the operational force onto the trigger 60, the control unit 95 does not supply the electric power to the solenoid 78. Therefore, the plunger 84 is in contact with the small diameter portion 81 of the cam 77 as shown in FIG. 7, and then, stops at the initial position.

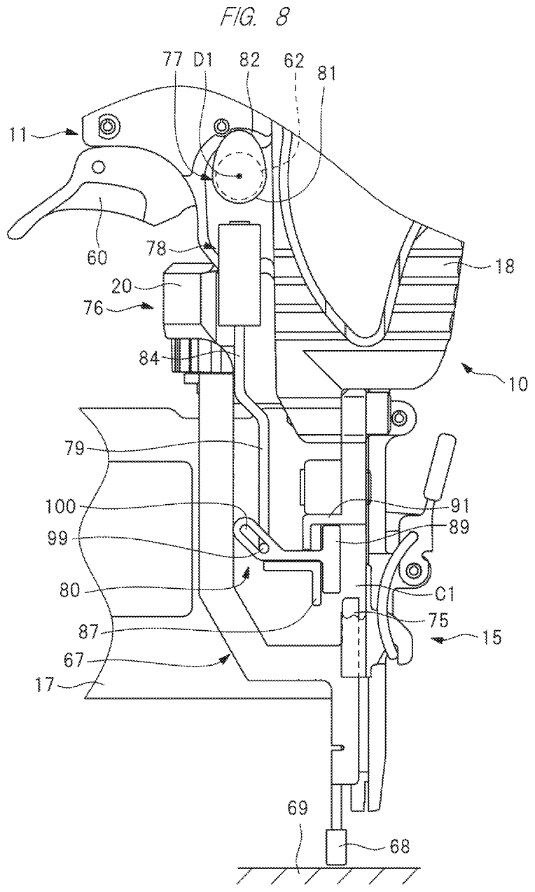

When the operator selects the second mode while applying the operational force onto the trigger 60, the control unit 95 supplies the electric power to the solenoid 78. Then, the plunger 84 moves from the initial position, and the plunger 84 stops at an operational position shown in FIG. 8. In other words, the plunger 84 is away from the cam 77. When the plunger 84 stops at the operational position, the engaging unit 89 is positioned out of the space C1, and then, the stopper 80 stops. And, if the contactor 68 is pressed against the workpiece 69 when the elapsed time is within the predetermined time, the control unit 95 continues to supply the electric power to the solenoid 78. And, the control unit 95 resets the counted elapsed time.

On the other hand, when the counted elapsed time exceeds the predetermined time while the contactor 68 is away from the workpiece 69, the control unit 95 stops supplying the electric power to the solenoid 78. Then, the plunger 84 returns from the operational position shown in FIG. 8 to the initial position shown in FIG. 7, and then, stops. Therefore, in the driving tool 10 of the second embodiment, the same effect as that of the driving tool 10 of the first embodiment can be obtained.

### Third Embodiment

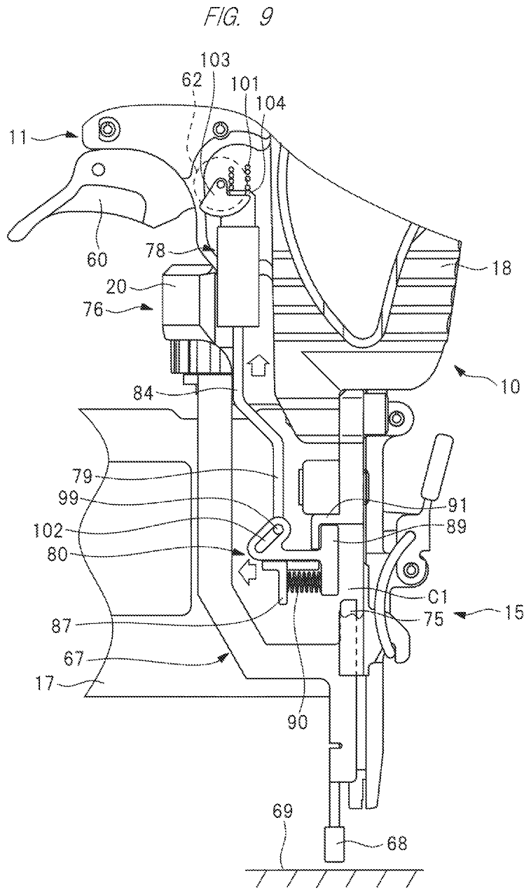

A third embodiment of the driving tool is shown in FIGS. 9, 10 and 11. The switching mechanism 76 has an urging member 101, and the urging member 101 urges the plunger 84 in a direction of bringing the plunger close to the stopper 80. The direction in which the urging member 101 urges the plunger 84 is opposite to the direction in which the urging member 85 in the first or second embodiment urges the plunger 84.

The moving member 79 is unified with the plunger 84, and the stopper 80 is provided with a guide hole 102. The guide hole 102 is a long hole. An inclination direction of the guide hole 102 is opposite to the inclination direction of the guide hole 100 in the second embodiment. The moving member 79 is provided with the pin 99, and the pin 99 is movable within the guide hole 102. The urging member 90 is included, and the urging member 90 urges the stopper 80 so that the stopper goes close to the space C1.

An engaging unit 103 is attached to the main shaft 62. The engaging unit 103 rotates and stops together with the main shaft 62. An engaging unit 104 is attached to the plunger 84. When the engaging unit 103 rotates, the engaging unit 103 is engaged with and released from the engaging unit 104.

(Example of Selection of First Mode by Operator)

When the operator selects the first mode, the engaging unit 103 engages with the engaging unit 104 as shown in FIG. 9, and the plunger 84 stops at the operational position. When the plunger 84 stops at the operational position, the stopper 80 stops in a state with the engaging unit 89 being out of the space C1. Therefore, when the operator presses the contactor 68 against the workpiece 69, the push lever 67 is movable. When the operator presses the contactor 68 against the workpiece 69 while applying the operational force onto the trigger 60, the state of the trigger valve 51 shown in FIG. 1B is switched from the initial state to the moving state, and the striking unit 13 moves from the top dead enter to the bottom dead center.

(Example of Selection of Second Mode by Operator)

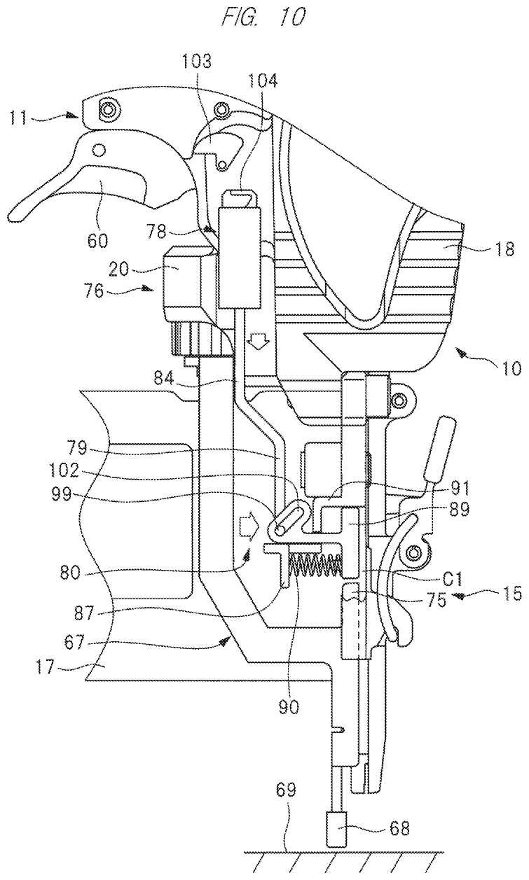

When the operator selects the second mode, the engaging unit 103 is released from the engaging unit 104 as shown in FIG. 10. At the moment of no application of the operational force on the trigger 60, the control unit 95 does not supply the electric power to the solenoid 78. Therefore, the plunger 84 stops at the initial position as shown in FIG. 10. When the plunger 84 stops at the initial position, the stopper 80 stops, and the engaging unit 89 is positioned at the space C1.

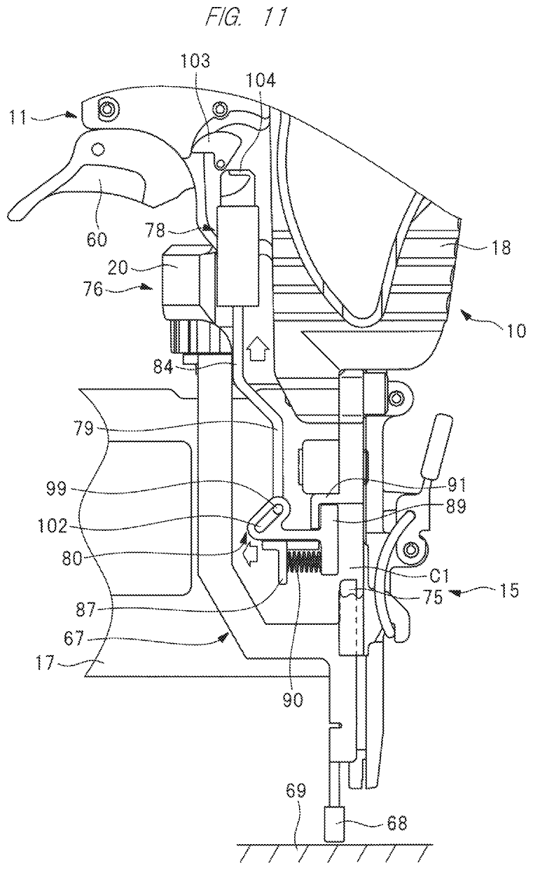

When the operator selects the second mode while applying the operational force onto the trigger 60, the control unit 95 supplies the electric power to the solenoid 78. Then, the plunger 84 moves from the initial position shown in FIG. 10, and then, the plunger 84 stops at an operational position shown in FIG. 11. When the plunger 84 stops at the operational position, the stopper 80 stops, and the engaging unit 89 is positioned out of the space C1. And, if the operator presses the contactor 68 against the workpiece 69 when the counted elapsed time is within the predetermined time, the control unit 95 continues to supply the electric power to the solenoid 78, and resets the counted elapsed time. Therefore, the push lever is movable, the moving force of the transfer member 72 is transferred to the trigger valve 51 through the arm 64, the state of the trigger valve 51 is switched from the initial state to the moving state, and the striking unit 13 moves from the top dead center to the bottom dead center.

On the other hand, when the counted elapsed time that is counted by the control unit 95 exceeds the predetermined time while the contactor 68 is away from the workpiece 69, the control unit 95 stops supplying the electric power to the solenoid 78. Then, the plunger 84 moves from the operational position shown in FIG. 11 to the initial position shown in FIG. 10, and then, stops. Therefore, when the push lever 67 is in contact with an object except for the workpiece 69 into which the nail 59 is struck, the striking unit 13 can be prevented from moving from the top dead center to the bottom dead center.

When the electric power cannot be supplied to the solenoid 78, if the operator selects the first mode by operating the mode selecting member 63, the stopper 80 stops, and the engaging unit 89 is positioned out of the space C1. Therefore, in the third embodiment of the driving tool 10, the same effect as that of the first embodiment of the driving tool 10 can be obtained.

### Fourth Embodiment

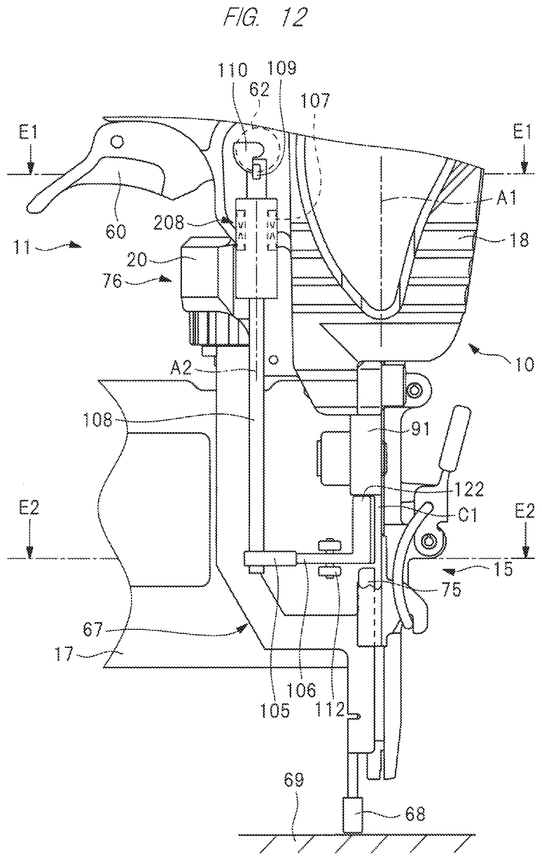

A fourth embodiment of the driving tool 10 will be explained with reference to FIGS. 12, 13 and 14. The switching mechanism 76 includes a rotary solenoid 208, an arm 105 and a stopper 106. The rotary solenoid 208 is one example of an actuator 120, and includes a coil 107 and a plunger 108. When the electric current flows in the coil 107, a torque having a predetermined angle is generated in the plunger 108 by a magnetic suction force. The plunger 108 is rotatable around the centerline A2. An outer circumferential surface of the plunger 108 is provided with a pin 109.

The main shaft 62 is provided with the stopper 110. The stopper 110 has a hook shape. When the main shaft 62 rotates, the stopper 110 is engaged with or released from the pin 109. In the switching from the first mode to the second mode, the main shaft 62 is set so as to be rotatable clockwise in FIG. 12 by a predetermined angle. In the switching from the second mode to the first mode, the main shaft 62 is set so as to be rotatable counterclockwise in FIG. 12 by a predetermined angle.

The arm 105 is fixed to the plunger 108. The arm 105 has a concave portion 121. An urging member 111 shown in FIG. 14 is included. One example of the urging member 111 is a metallic spring. The urging member 111 applies a clockwise torque to the plunger 108 and the arm 105. A direction of the torque applied to the plunger 108 by the urging member 111 is opposite to a direction of a torque applied to the plunger 108 by the energization to the coil 107. When the stopper 110 is engaged with the pin 109 by the application of the torque from the urging member 111 to the plunger 108, the stopper 110 prevents the plunger 108 from rotating.

The injection unit 15 is provided with a support shaft 112, and the stopper 106 is a lever that is movable within a predetermined angle range so that the support shaft 112 is a pivot point. The stopper 106 includes an engaging unit 122. The engaging unit 122 has a length in the direction of the centerline A1. An end of the stopper 106, the end being on an opposite side of the engaging unit 122, is arranged in the concave portion 121. In other words, the arm 105 and the stopper 106 are connected to each other so that the moving force can be transferred.

When the plunger 108 rotates within a predetermined angle range, the arm 105 moves within a predetermined angle range. The moving force of the arm 105 is transferred to the stopper 106, and the stopper 106 moves within a predetermined angle range so that the support shaft 112 is a pivot point. When the stopper 106 moves, the engaging unit 122 can go into and out of the space C1.

A control system shown in FIG. 5 can be used for the driving tool 10 shown in FIG. 12. The rotary solenoid 208 is connected to the power supply 96 through the switching circuit 97. The control unit 95 can control the supply of the electric power from the power supply 96 to the rotary solenoid 208 and the stoppage of the supply.

(Example of Selection of First Mode by Operator)

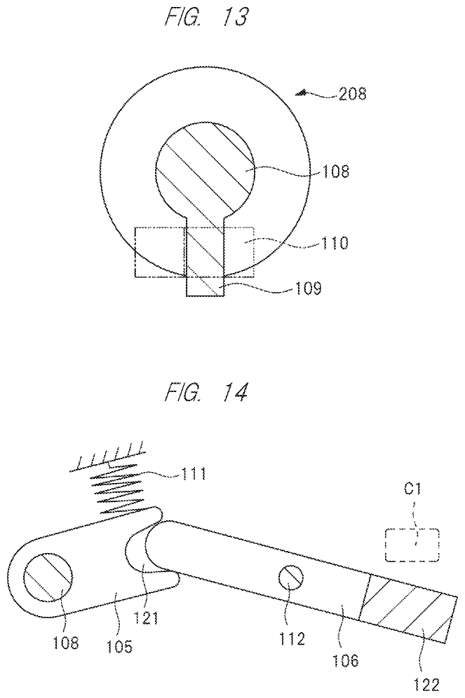

When the operator selects the first mode, the stopper 110 engages with the pin 109 as shown in FIGS. 12 and 13. The arm 105 and the plunger 108 stop so as to be against the force of the urging member 111. And, the stopper 106 stops, and the engaging unit 122 is positioned out of the space C1. Therefore, when the operator presses the edge against the workpiece 69, the push lever 67 is movable. When the operator presses the contactor 68 against the workpiece 69 while applying the operational force onto the trigger 60, the state of the trigger valve 51 is switched from the initial state to the moving state, and the striking unit 13 moves from the top dead center to the bottom dead center.

(Example of Selection of Second Mode by Operator)

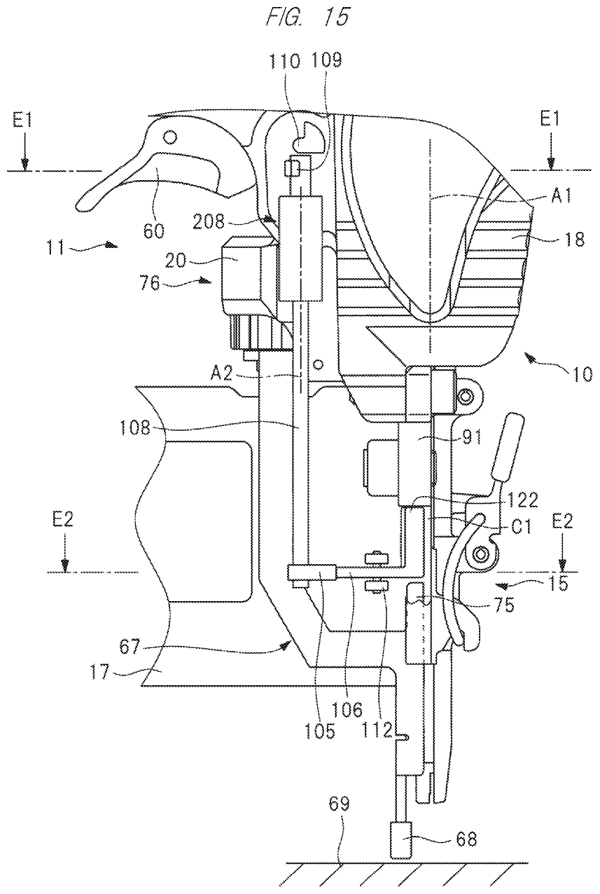

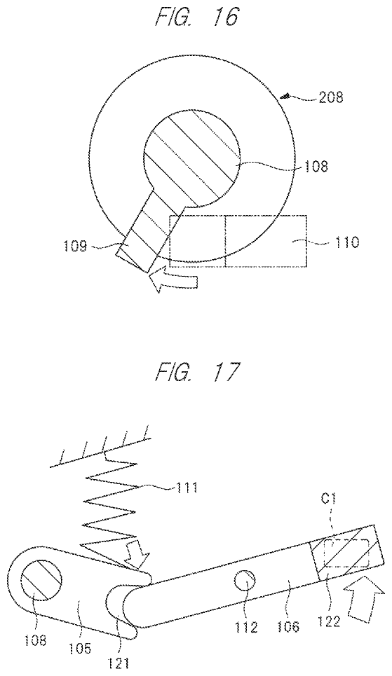

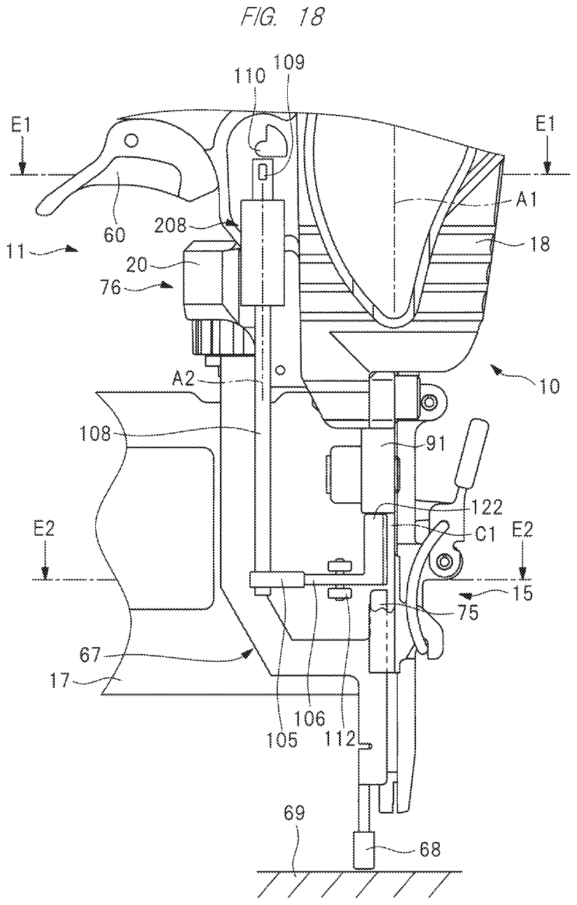

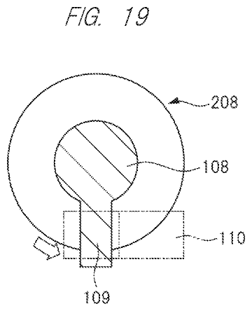

When the operator selects the second mode while not applying the operational force onto the trigger 60, the control unit 95 does not supply the electric power to the rotary solenoid 208. Then, as shown in FIGS. 15 and 16, the stopper 110 is released from the pin 109. As shown in FIG. 17, the arm 105 is moved clockwise together with the plunger 108 by the urging force of the urging member 111, the arm 105 stops, and the stopper 106 stops. At least a part of the engaging unit 122 is positioned at the space C1.

When the operator selects the second mode while applying the operational force onto the trigger 60, the control unit 95 supplies the electric power to the rotary solenoid 208. Then, the plunger 108 moves counterclockwise from a position shown in FIGS. 16 and 17, and then, the plunger 108 stops at a position shown in FIGS. 14 and 19 . When the plunger 108 and the arm 105 stop while the stopper 106 stops, the engaging unit 122 is positioned out of the space C1. And, if the operator presses the edge against the workpiece 69 when the counted elapsed time is within the predetermined time, the control unit 95 continues to supply the electric power to the rotary solenoid 208, and resets the counted elapsed time. Therefore, the moving force of the push lever 67 is transferred to the trigger valve 51 through the transfer member 72, the state of the trigger valve 51 is switched from the initial state to the moving state, and the striking unit 13 moves from the top dead center to the bottom dead center.

On the other hand, when the counted elapsed time that is counted by the control unit 95 exceeds the predetermined time while the contactor 68 is away from the workpiece 69, the control unit 95 stops supplying the electric power to the rotary solenoid 208. Then, the plunger 108 moves clockwise from the position shown in FIGS. 14 and 19, and then, stops at the position shown in FIGS. 16 and 17. And, the stopper 106 stops, and at least a part of the engaging unit 122 is positioned at the space C1. Therefore, when the push lever 67 is in contact with an object except for the workpiece 69 into which the nail 59 is struck, the push lever 67 can be prevented from moving. Thus, the striking unit 13 can be prevented from moving from the top dead center to the bottom dead center.

When the operator selects the second mode while the electric power cannot be supplied to the rotary solenoid 208, if the operator switches the mode from the second mode to the first mode by operating the mode selecting member 63, the stopper 110 engages with the pin 109, and the plunger 108 is moved clockwise in FIGS. 16 and 17 by the moving force of the stopper 110, and then, stops. When the stopper 106 stops as shown in FIG. 14, the engaging unit 122 is positioned out of the space C1. Therefore, in the fourth embodiment of the driving tool 10, the same effect as that of the first embodiment of the driving tool 10 can be obtained.

(First Control Example)

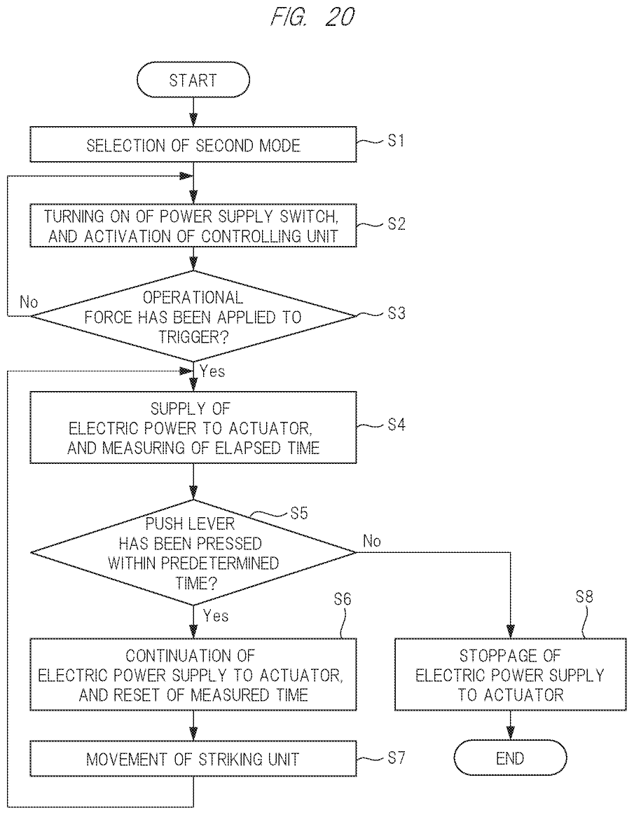

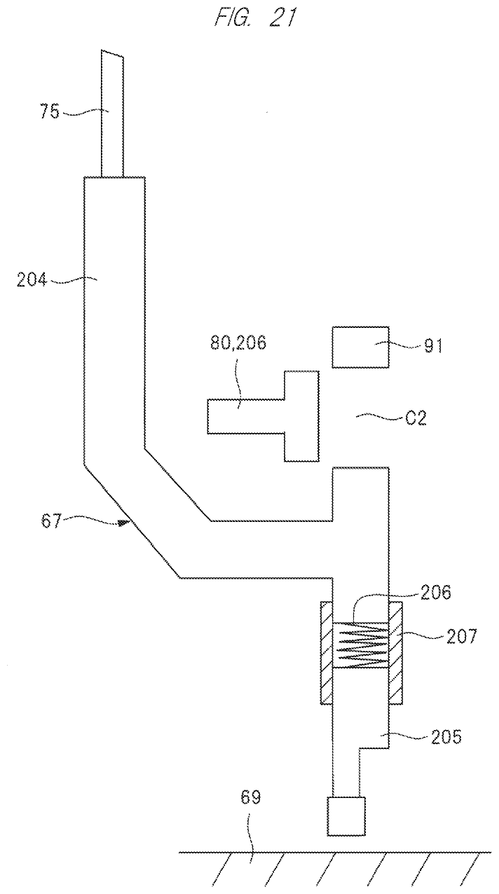

FIG. 20 shows a first control example performed in at least one embodiment of the first, second, third and fourth embodiments of the driving tool 10. When the operator selects the second mode at a step S1, the power supply switch 94 is turned ON while the control unit 95 is activated at a step S2. At a step S3, the control unit 95 determines whether or not the operational force has been applied onto the trigger 60. When the control unit 95 determines its result as “No” at the step S3, the process proceeds to the step S2.

When the control unit 95 determines its result as “Yes” at the step S3, the electric power is supplied to the actuator 120 while the counting of the elapsed time is started at a step S4. At a step S5, the control unit 95 determines whether or not the push lever 67 has been pressed against the workpiece 69 within the predetermined time that is elapsed from a moment of the operation of the trigger 60.

When the control unit 95 determines its result as “Yes” at the step S5, the counted elapsed time is reset while the supply of the electric power to the actuator 120 is contained at a step S6. At a step S7, the striking unit 13 moves from the top dead center to the bottom dead center, and the process proceeds to the step S4.

When the control unit 95 determines its result as “No” at the step S5, the supply of the electric power to the actuator 120 is stopped while the counted elapsed time is reset at a step S8, and the first control example of FIG. 15 ends.

When the control unit 95 supplies the electric power to the actuator 120 in one or more embodiments of the first to fourth embodiments of the driving tool, the control unit 95 can select any of first control, second control and third control. The first control is to control the supply of the electric power to the actuator 120 when the second mode is selected while the operational force is applied to the trigger 60. The second control is to control the supply of the electric power to the actuator 120 when the second mode is selected. The third control is to control the supply of the electric power to the actuator 120 when the second mode is selected while the push lever 67 is pressed against the workpiece 69.

In the case of the third control, a gap is formed between the engaging unit 75 and the stoppers 80, 106. Then, when the push lever 67 is pressed against the workpiece 69 while the electric power is supplied to the actuator 120 before the engaging unit 75 is in contact with the stopper 80 or the stopper 106, the stopper 80 or the stopper 106 goes out of the space C1. Therefore, the stopper 80, 106 does not block the movement of the push lever 67, and the moving force of the push lever 67 is transferred to the plunger 52 of the trigger valve 51 through the transfer member 72.

As shown in FIG. 21, the push lever 67 is made of a first element 204 and a second element 205 that are separated from each other in the moving direction. A tubular member 207 is attached to the first element 204, and apart of the second element 205 is arranged inside the tubular member 207. The second element 205 is movable with respect to the first element 204. An elastic member 206 is inserted between the first element 204 and the second element 205. Types of the elastic member 206 include a metallic spring and a synthetic rubber. The first element 204 is connected to the transfer member 72. The stopper 80 can go into and out of the space C2. The second element 205 can be in contact with and away from the workpiece 69.

In the case of the push lever 67 having such a configuration, when the second element 205 is pressed against the workpiece 69 in the state with the stopper 80 being positioned at the space C2, the movement of the first element 204 is prevented by the stopper 80. The second element is movable within a deformation amount range of the elastic member 206. In other words, although the second element 205 that is a part of the push lever 67 is movable, the moving force of the second element 205 is not transferred to the transfer member 72. Note that the stopper 106 can be provided in place of the stopper 80.

Technical implications of matters explained in the embodiments are as follows. The driving tool 10 is one example of the driving tool, the trigger 60 is one example of the operational member, and the push lever 67 is one example of the contact member. The piston upper chamber 29 is one example of the pressure chamber. The striking unit 13 is one example of the striking unit. Each of the trigger valve 51, the head valve 22, the control chamber 25, the port 30 and the exhaust port 125 is one example of the driving unit. The mode selecting member 63 is one example of the mode selecting member.

The state with the trigger valve 51 in the moving state and with the head valve 22 opening the port 30 is one example of the supply state of the driving unit. The state with the trigger valve 51 in the initial state and with the head valve 22 opening the exhaust port 125 is one example of the exhaust state of the driving unit.

The state with the engaging unit 89 of the stopper 80 being positioned at the space C1 or the state with the engaging unit 122 of the stopper 106 being positioned at the space C1 is one example of the first state of the switching mechanism. The state with the engaging unit 89 of the stopper 80 being positioned out of the space C1 or the state with the engaging unit 122 of the stopper 106 being positioned out of the space C1 is one example of the second state of the switching mechanism.

Each of the solenoid 78, the rotary solenoid 208, the moving member 79 and the stoppers 80 and 106 is one example of the switching mechanism. The port 30 is one example of the supply port, and the exhaust port 125 is one example of the exhaust port. The trigger valve 51 is one example of the valve. The power supply 96 is one example of the power supply, and the control unit 95 is one example of the control unit. Each of the solenoid 78 and the rotary solenoid 208 is one example of the release mechanism. Each of the stoppers 80 and 106 is one example of the prevention member. The space C1 is one example of the moving range. Each of the urging members 90 and 111 is one example of the maintaining mechanism. The injection unit 15 is one example of the guide unit. The first mode can be defined as single shot while the second mode can be defined as successive shot.

The driving tool is not limited to the disclosed embodiments, and various modifications can be made within the scope of the present invention. For example, types of the compressed gas include not only the air but also inert gas such as nitrogen gas and rare gas.

Types of the operational member include a lever, a button, an arm and others. The operational member may rotate within the predetermined angle range or linearly reciprocate. Types of the contact member include a lever, a shaft, an arm and others. The contact member can linearly reciprocate.

As the actuator, an electrical motor can be used in place of the solenoid or the rotary solenoid. As the electric motor, so-called stepper motor or pulse motor can be used. Examples of the stoppage of the electric power supply to the actuator include the following two examples. The first example is a case in which a voltage of the power supply is smaller than a necessary voltage for activating the actuator. The second example is a case in which an electric circuit between the power supply and the actuator is short-circuited.

The control unit may be single electric or electronic component, or a unit having a plurality of electric or electronic components. Types of the electric or electronic component include a processor, a control circuit and a module.

Types of the pressure chamber and the control chamber include a space, a region and a path, to/from which the compressed gas is supplied/exhausted. Types of the supply port through which the compressed gas is supplied to the pressure chamber include a port, a path, a hole and a gap. Types of the exhaust port through which the compressed gas is exhausted from the pressure chamber include a port, a path, a hole and a gap.

### Fifth Embodiment

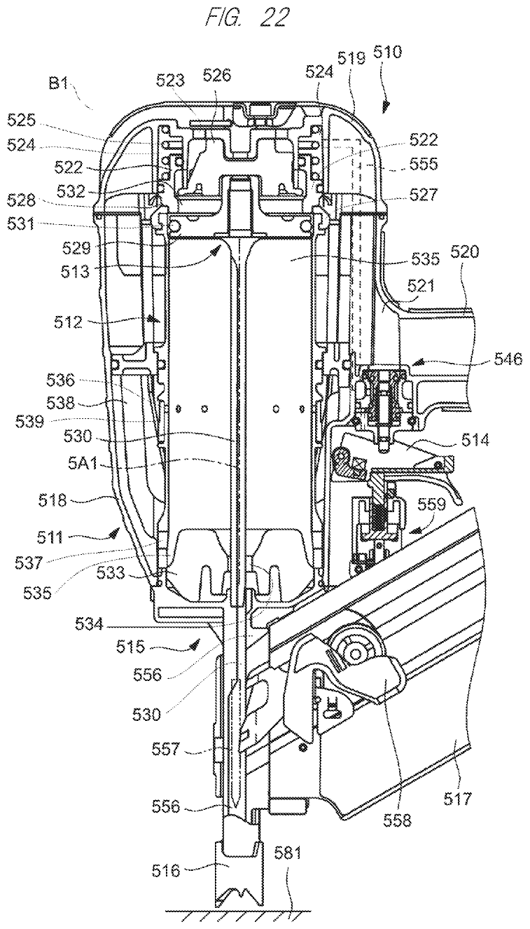

A fifth embodiment of the driving tool will be explained with reference to FIG. 22. A driving tool 510 includes a main body 511, a cylinder 512, a striking unit 513, a trigger 514, an injection unit 515 and a push lever 516. A magazine 517 is attached to the driving tool 510. The main body 511 includes a tubular body portion 518, a head cover 519 fixed to the body portion 518, and a handle 520 connected to the body portion 518. The handle 520 protrudes from an outer surface of the body portion 518.

As shown in FIG. 22, a pressure accumulating chamber 521 is formed over inside of the handle 520, inside of the body portion 518 and inside the head cover 519. A plug is attached to the handle 520, and an air hose is connected to the plug. The compressed air serving as the compressed gas is supplied into the pressure accumulating chamber 521 through the air hose. The cylinder 512 is arranged inside the body portion 518.

A head valve 522 is arranged inside the head cover 519. The head valve 522 has a tubular shape and is movable in a direction of a centerline 5A1 of the cylinder 512. The head valve 522 includes a gas-exhaust path 523. The gas-exhaust path 523 communicates with the outside B1 of the main body 511. A control chamber 524 is formed between the head cover 519 and the head valve 522. An urging member 525 is arranged in the control chamber 524. One example of the urging member 525 is a metallic compressed coil spring. The stopper 526 is attached to the head cover 519. The stopper 526 is made of, for example, a synthetic rubber.

The cylinder 512 is fixed to be oriented to the body portion 518 in the direction of the centerline 5A1. A valve seat 527 is attached to an end of the cylinder 512, the end being the closest to the head valve 522 in the direction of the centerline 5A1. The valve seat 527 is annular, and is made of a synthetic rubber. A port 528 is formed between the head valve 522 and the valve seat 527.

The head valve 522 is urged by an urging force of the urging member 522 and a pressure of the control chamber 524 in a direction of going close to the valve seat 527 in the direction of the centerline 5A1. Further, the head valve 522 is urged by a pressure of the pressure accumulating chamber 521 in a direction of going away from the valve seat 527. When the head valve 522 is pressed against the valve seat 527, the head valve 522 closes the port 528. When the head valve 522 goes away from the valve seat 527, the head valve 522 opens the port 528.

The striking unit 513 includes a piston 529 and a driver blade 530 fixed to the piston 529. The piston 529 is arranged inside the cylinder 512, and the piston 529 is movable in the direction of the centerline 5A1. A sealing member 531 is attached to an outer circumferential surface of the piston 529. A piston upper chamber 532 is formed between the stopper 526 and the piston 529. When the head valve 522 opens the port 528, the compressed air of the pressure accumulating chamber 521 communicates with the piston upper chamber 532, and besides, the head valve 522 disconnects the piston upper chamber 532 from the gas-exhaust path 523. When the head valve 522 closes the port 528, the pressure accumulating chamber 521 is disconnected from the piston upper chamber 532, and besides, the piston upper chamber 532 and the gas-exhaust path 523 are connected to each other.

The injection unit 515 is fixed to an end of the body portion 518, the end being opposite to a portion having the head cover 519 in the direction of the centerline 5A1.

As shown in FIG. 22, a bumper 533 is arranged inside the cylinder 512. Inside the cylinder 512, the bumper 533 is arranged at a position that is the closest to the injection unit 515 in the direction of the centerline 5A1. The bumper 533 is made of a synthetic rubber or a silicon rubber. The bumper 533 includes a shaft hole 534, and the driver blade 530 is movable inside the shaft hole 534 in the direction of the centerline 5A1. Inside the cylinder 512, a piston lower chamber 535 is formed between the piston 529 and the bumper 533. The sealing member 531 air-tightly closes a gap between the piston lower chamber 535 and the piston upper chamber 532.

Paths 536 and 537 that penetrate the cylinder 512 in a radial direction are arranged. The path 537 is arranged between the path 536 and the injection unit 515 in the direction of the centerline 5A1. A return air chamber 538 is formed between the outer surface of the cylinder 512 and the body portion 518. A non-return valve 539 is arranged in the cylinder 512. A region from the piston lower chamber 535 to the return air chamber 538 is filled with the compressed air.

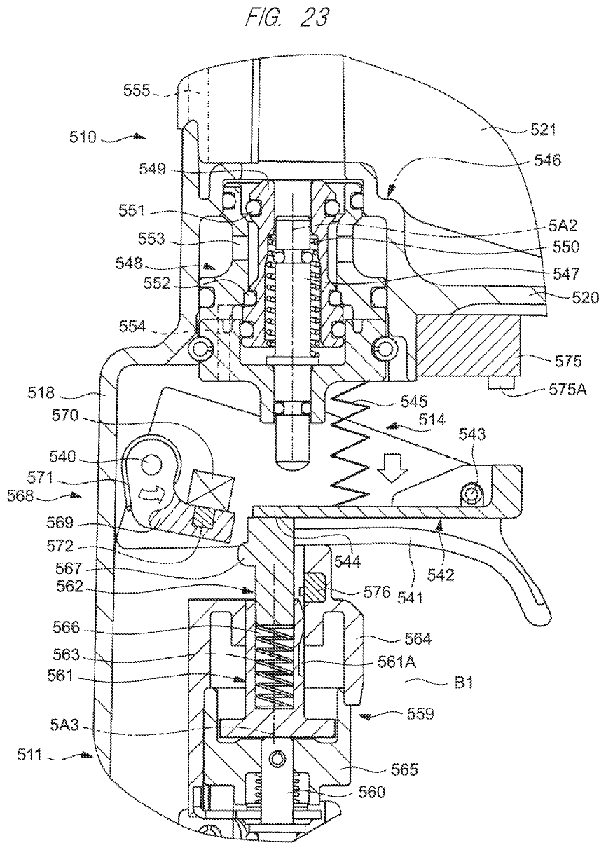

As shown in FIGS. 22 and 23, a trigger 514 is attached to the main body 511. The trigger 514 is attached to the main body 511 through a support shaft 540. The trigger 514 is movable, in other words, rotatable within a predetermined angle range around the support shaft 540 serving as its center. The trigger 514 includes a stopper 541. The operator applies or releases the operational force onto/from the trigger 514 while grasping the handle 520 using his/her hand, the trigger 512 moves counterclockwise in FIG. 23. When the operator applies the operational force onto the trigger 514, the trigger 514 moves counterclockwise in FIG. 23.

An arm 542 is attached to the trigger 514. The arm 542 is movable within a predetermined angle range from the trigger 514 around the support shaft 543 serving as its center. A free end 544 of the arm 542 is positioned between the support shaft 540 and the support shaft 543 in a longitudinal direction of the trigger 514.

An urging member 545 is arranged for urging the arm 542 so as to take the support shaft 543 as its center. One example of the urging member 545 is a metallic spring. The urging member 545 urges the arm 542 counterclockwise in FIG. 23. A part of the urging force applied on the arm 542 is transferred to the trigger 514. The trigger 514 is urged clockwise in FIG. 23 by the urging member 545.

As shown in FIGS. 22 and 23, a trigger valve 546 is arranged at a connecting portion between the body portion 518 and the handle 520. The trigger valve 546 includes a plunger 547, a body 548, a valve disc 549, an urging member 550, sealing members 551 and 552 arranged in the valve disc 549, a path 553 arranged in the body 548 and a gas-exhaust path 554. The gas-exhaust path 554 communicates with the outside B1. A path 555 is arranged in the main body 511, and the path 553 communicates with a control chamber 524 through the path 555.

The plunger 547 is movable in a direction of a centerline 5A2, and the valve disc 549 moves and stops in the direction of the centerline 5A2 in accordance with a position of the plunger 547 in the direction of the centerline 5A2. In accordance with a position of the valve disc 549 in the direction of the centerline 5A2, each of the sealing members 551 and 552 is in contact with or away from the body 548. When the sealing member 551 is away from the body 548, the pressure accumulating chamber 521 and the path 553 are connected to each other, and besides, the sealing member 552 is in contact with the body 548 so that the path 553 and the gas-exhaust path 554 are disconnected from each other. When the sealing member 551 is in contact with the body 548, the pressure accumulating chamber 521 and the path 553 are disconnected from each other, and besides, the sealing member 552 is away from the body 548 so that the path 553 and the gas-exhaust path 554 are connected to each other.

The injection unit 515 shown in FIG. 22 is made of, for example, metal or non-metal. The injection unit 515 includes an injection path 556. The centerline 5A1 is positioned inside the injection path 556, and the driver blade 530 is movable inside the injection path 556 in the direction of the centerline 5A1.

The magazine 517 is fixed to the injection unit 515. The magazine 517 houses a nail 557. The magazine 517 includes a feeder 558, and the feeder 558 feeds the nail 557 inside the magazine 517 to the injection path 556.

The push lever 516 is attached to the injection unit 515. The push lever 516 is movable within a predetermined range from the injection unit 515 in the direction of the centerline 5A1. A transfer mechanism 559 shown in FIGS. 22 and 23 is provided. The transfer mechanism 559 transfers a moving force of the push lever 516 to the plunger 547. The transfer mechanism 559 includes a plunger 560, a cylinder 561, a pin 52 and an urging member 563. Each of the plunger 560, the cylinder 561 and the pin 562 is made of a metal. The main body 511 is provided with a holder 564 and an adjustor 565. The holder 564 has a tubular shape, and each of the holder 564 and the adjustor 565 supports the cylinder 561 so as to be movable. The plunger 560, the cylinder 561 and the pin 562 are movable in a direction of a centerline 5A3. The centerline 5A2 and the centerline 5A3 are parallel to each other. Note that the centerline 5A2 and the centerline 5A3 may coaxial to each other.

The push lever 516 and the plunger 560 are connected to each other so that the moving force can be transferred. The plunger 560 and the cylinder 561 are connected to each other so that the moving force can be transferred. The cylinder 561 includes a supporting hole 566, and the urging member 563 is arranged in the supporting hole 566. A part of the pin 562 in the direction of the centerline 5A3 is arranged in the supporting hole 566, and another part of the pin 562 in the direction of the centerline 5A3 is arranged out of the supporting hole 566. One example of the urging member 563 is a metallic compressed spring. The urging member 563 urges the pin 562 in a direction of going close to the trigger valve 546 in the direction of the centerline 5A3. A spring constant of the urging member 563 is larger than a spring constant of the urging member 550. A concave portion 561A is arranged in an outer circumferential surface of the cylinder 561. An engaging unit 567 is arranged in an outer surface of a part of the pin 562, the part being out of the supporting hole 566. An outer surface of the engaging unit 567 has an arc shape. A free end 544 of the arm 542 is arranged between the plunger 547 and the pin 562 in the direction of the centerline 5A3.

A prevention mechanism 568 shown in FIG. 23 is provided. The prevention mechanism 568 shown in FIG. 23 is arranged in, for example, the trigger 514. The prevention mechanism 568 has a function of blocking the transfer of the moving force from the pin 562 to the plunger 547. The prevention mechanism 568 includes a stopper 569, an electromagnet 570 and an urging member 571. The stopper 569 is made of a synthetic resin or a metal, and the stopper 569 is supported by the support shaft 540. The stopper 569 is movable, in other words, rotatable within a predetermined angle range from the trigger 514 around the support shaft 540 serving as its center. A permanent magnet 572 is attached to the stopper 569. One example of the urging member 571 is a twisted metallic coil spring. The urging member 571 urges the stopper 569 counterclockwise in FIG. 23.

The electromagnet 570 has a magnetic material and a conductive coil. In the electromagnet 570, a magnetic force is generated when electric current flows through the coil, and the magnetic force disappears when the electric current does not flow through the coil. A direction of the electric current flowing through the coil is set so that the magnetic force generated in the electromagnet 570 is against the magnetic force of the permanent magnet 572. In other words, A polar of the electromagnet 570 is the same as a polar of the permanent magnet 572. The electromagnet 570 is arranged within the moving range of he stopper 569. When the electric current does not flow in the electromagnet 570, the stopper 569 that is urged by the urging member 571 is pressed against the electromagnet 570, and then, stops at the initial position. When the electric power is supplied to the electromagnet 570 so that the electromagnet 570 generates the magnetic force, the stopper 569 moves clockwise in FIG. 23 so as to be the urging force of the urging member 571, and stops at a position that is away from the electromagnet 570.

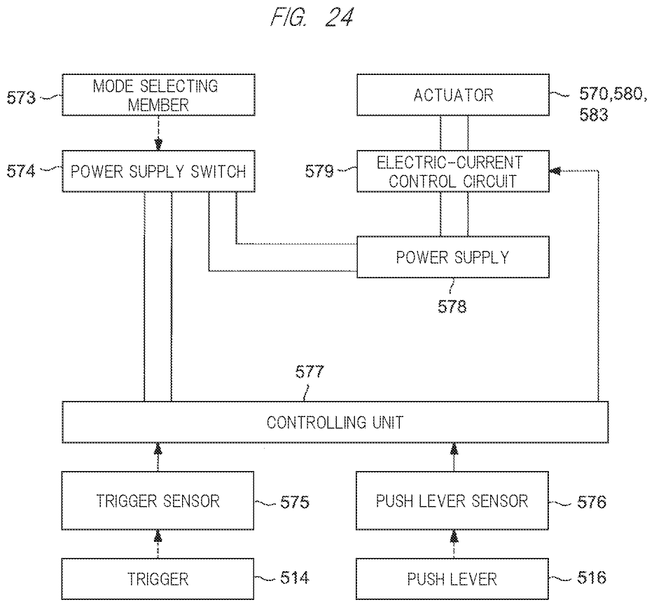

FIG. 24 is a block diagram showing a control system of the driving tool 510. The driving tool 510 includes a mode selecting member 573, a power supply switch 574, a trigger sensor 575, a push lever sensor 576, a control unit 577, a power supply 578, an electric-current control circuit 579, and an actuator 580. The electric-current control circuit 579 is arranged between the power supply 578 and the actuator 580. As one example of the power supply 578, a battery pack can be used. The battery pack includes a case and a battery housed inside the case. The battery pack can be attached to/detached from an outer surface of the main body 511 or an outer surface of the magazine 517.

The mode selecting member 573 is arranged in the main body 511. One example of the mode selecting member 573 is a lever that is movable within a predetermined angle range. The mode selecting member 573 has a first operational position corresponding to a first mode and a second operational position corresponding to a second mode. In the first mode, the operator applies the operational force onto the trigger 514 in a state with the push lever 516 shown in FIG. 22 being in contact with the workpiece 581. In the second mode, the push lever 516 is brought into contact with the workpiece 581 in a state with the operator applying the operational force onto the trigger 514. The operator selects the first mode or the second mode by operating the mode selecting member 573 in a state with the released operational force on the trigger 514 and with the push lever 516 being away from the workpiece 581.

The power supply switch 574 disconnects the power supply 578 from the control unit 577 when the mode selecting member 573 is at the first operational position, and connects the power supply 578 and the control unit 577 when the mode selecting member 573 is at the second operational position. One example of the power supply switch 574 is a contact switch such as a tactile switch. The electric-current control circuit 579 includes, for example, a plurality of electric field effect transistors.

The trigger sensor 575 outputs a signal depending on whether the operational force on the trigger 514 exists and depending on the moving state of the push lever 516. As one example of the trigger sensor 575, a contact sensor can be used. The trigger 514 is movable between the initial position and the operational position. The initial position of the trigger 514 is a position at which a part of the trigger 514 is in contact with the holder 564 and then stops as shown in FIG. 23. Note that a position at which the arm 542 is brought into contact with the pin 562 by the force of the urging member 545 so that the trigger 514 stops can be defined as the initial position. The operational position of the trigger 514 is a position at which a part of the trigger 514 is in contact with the body 548 or the main body 511 so that the trigger 514 stops. The trigger sensor 575 includes a contactor 575A. The trigger sensor 575 is turned ON when an object is pressed against the contactor 575A, and the trigger sensor 575 is turned OFF when a pressing force of the object against the contactor 575A is reduced or when the object is away from the contactor. In the present embodiment, the trigger sensor 575 is turned ON or OFF in the following case.

When the trigger 514 stops at the initial position as shown in FIG. 23, the trigger sensor 575 is turned OFF regardless of the position of the push lever 516.

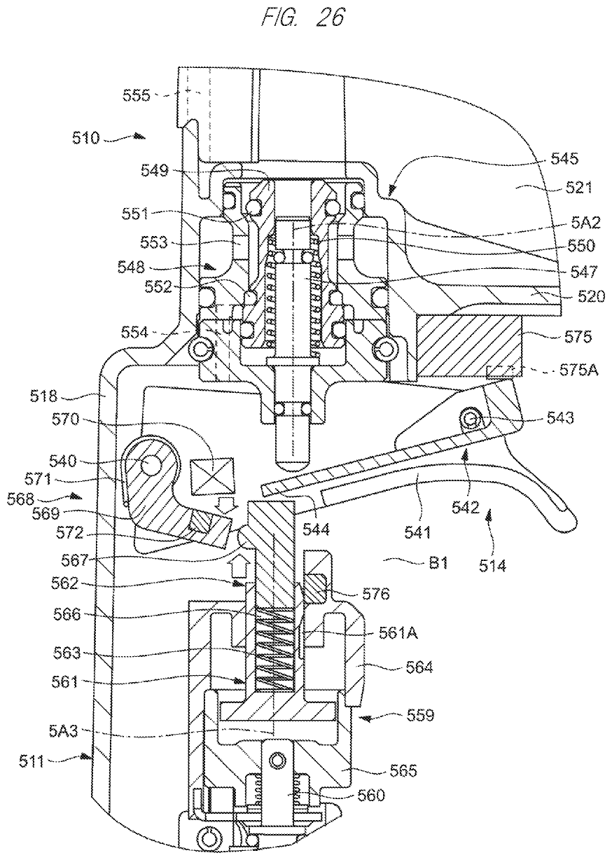

The trigger sensor 575 is turned ON when the trigger 514 onto which the operational force is applied stops at the operational position as shown in FIG. 26, and besides, when the push lever 516 is away from the workpiece 581. The trigger sensor 575 is turned ON when the trigger 514 that stops at the operational position is not in contact with the trigger sensor 575, and when a part of the arm 542 pushes the contactor 575A.

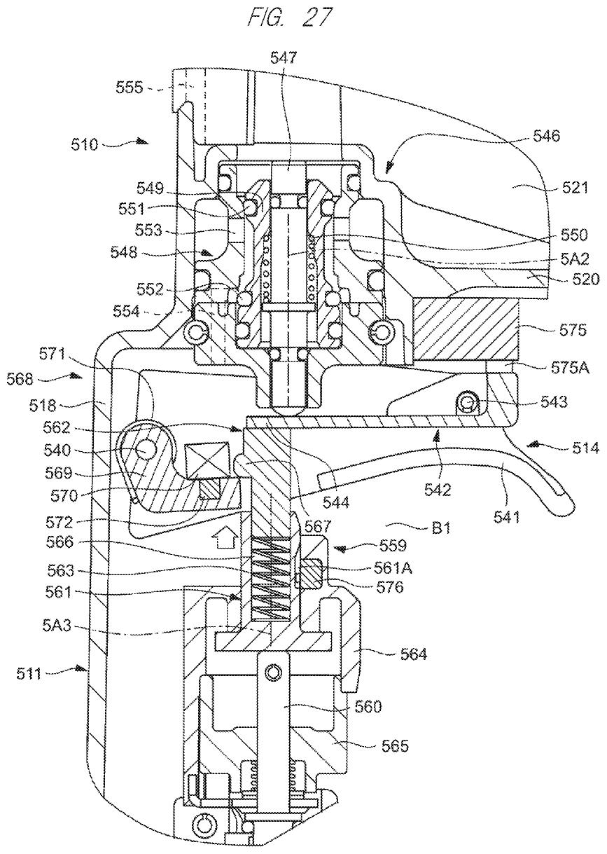

As shown in FIG. 26, when the trigger sensor 575 is turned ON, if the pin 562 is moved from the initial position and the pin 562 reaches the operational position shown in FIG. 27 by the pressing of the push lever 516 against the workpiece 581, then, the trigger sensor 575 is turned OFF. This is because the pressing force from the arm 542 onto the contactor 575A is reduced. In the manner, the trigger sensor 575 can be turned ON and OFF in the state with the trigger 514 stopping at the operational position.

The trigger sensor 575 shown in FIG. 23 is arranged in, for example, an outer surface of the handle 520.

The push lever sensor 576 outputs a signal depending on which one of the initial position and the operational position the push lever 516 exists at and a signal depending on passage of the push lever 516 in a middle position between the initial position and the operational position. The present specification discloses an example of usage of a contact sensor as the push lever sensor 576, the contact sensor outputting a signal depending on a position of the cylinder 561 in the direction of the centerline 5A3 without directly sensing the plunger movement of the push lever 516. The push lever sensor 576 is turned OFF when the push lever 516 is at the initial position, in other words, when the push lever is away from the workpiece 581. The push lever sensor 576 is turned ON when the push lever 516 is at the middle position between the initial position and the operational position and is in contact with the pin 562. The push lever sensor 576 is turned OFF when the push lever 516 reaches the operational position. Specifically, at a position corresponding to the concave portion 561A, the push lever sensor 576 is away from the cylinder 561 and is turned OFF. The signals from the trigger 575 and the push lever sensor 576 are input to the control unit 577.

The control unit 577 is a microcomputer including an input interface, an output interface, a storage unit, a computing processor unit, and a timer. The control unit 577 is activated when the power supply switch 574 is turned ON, and is stopped when the power supply switch 574 is turned OFF. An actuator 580 includes the electromagnet 570. The control unit 577 controls the connection and the disconnection of the electric-current control circuit 579, and controls a direction of the electric current in the electromagnet 570.

The control unit 577 determines that the operational force has been applied onto the trigger 514 when the push lever 516 is away from the workpiece 581 while the trigger sensor 575 is turned ON. The control unit 577 determines that the push lever 516 has been pressed against the workpiece 581 and has been moved when the state of the push lever sensor 576 is changed from the turning OFF to the turning ON. The control unit 577 determines that the push lever 516 has been moved and reached the operational position when the state of the push lever sensor 576 is changed from the turning ON to the turning OFF.

(Example of Usage of Driving Tool)

Next, an example of usage of the driving tool 510 will be explained. When the operator releases the operational force from the trigger 514 while the push lever 516 is away from the workpiece 581, the trigger 514 is pressed against the holder 564, or the free end 544 of the arm 542 is pressed against a tip of the pin 562, so that each of the trigger 514 and the arm 542 stops at the initial position.

When the operator releases the operational force from the trigger 514 while the push lever 516 is away from the workpiece 581, the trigger valve 546, the head valve 522 and the striking unit 513 are in the following initial states.

When the trigger valve 546 is in the initial state, the pressure accumulating chamber 521 and the path 553 are connected to each other while the path 553 and the gas-exhaust path 554 are disconnected from each other. Therefore, the compressed air of the pressure accumulating chamber 521 is supplied to the control chamber 524, and the head valve 522 closes the port 528. In other words, the head valve 522 disconnects the pressure accumulating chamber 521 from the piston upper chamber 532. And, the head valve 522 connects the piston upper chamber 532 and the gas-exhaust path 523, and the piston upper chamber 532 communicates with the outside B1 through the gas-exhaust path 523. Therefore, a pressure of the piston upper chamber 532 is the same as the atmospheric pressure, and is lower than a pressure of the piston lower chamber 535. Therefore, the piston 529 stops while being pressed against the stopper 526 by the pressure of the piston lower chamber 535. In the manner, the striking unit 513 stops at the top dead center shown in FIG. 22.

The operator selects the first mode or the second mode by operating the mode selecting member 573 in a state with the releasing of the operational force from the trigger 514 and with the push lever 516 being away from the workpiece 581.

(Example of Selection of First Mode)

When the operator selects the first mode, the power supply switch 574 is tuned OFF. In other words, the electric power of the power supply 578 is not supplied to the control unit 577 so that the control unit 577 stops. And, the electric power is not supplied to the electromagnet 570. Therefore, the stopper 569 stops at the initial position at which the stopper is in contact with the electromagnet 570. When the trigger 514 stops at the initial position while the electric power is not supplied to the electromagnet 570, the stopper 569 that is stopping at the initial position is positioned out of the moving range of the pin 562, particularly out of the moving range of the engaging unit 567.

And, the operator presses the push lever 516 against the workpiece 581 in the state with the releasing of the operational force from the trigger 514. The push lever 516 is moved in a direction of going close to the bumper 533 by a reactive force of the pressing of the push lever 516 against the workpiece 581. The moving force of the push lever 516 is transferred to the pin 562 through the plunger 560, the urging member 563 and the cylinder 561. The pin 562 is moved in a direction of going close to the plunger 547 in the direction of the centerline 5A3. The stopper 569 is positioned out of the moving range of the engaging unit 567, and does not block the movement of the pin 562. The moving force of the pin 562 is transferred to the arm 542, and the arm 542 moves counterclockwise in FIG. 23. When the pin 562 stops, the arm 542 also stops. At this stage, the moving force of the arm 542 is not transferred to the plunger 547, and the trigger valve 546 is in the initial state.

When the operator applies the operational force onto the trigger 514 in the state with the push lever 516 being pressed against the workpiece 581, the trigger 514 moves counterclockwise in FIG. 23 around the support shaft 540 serving as its center. Then, the arm 542 moves together with the trigger 514. When the trigger 514 is pressed against the trigger sensor 575 and stops at the operational position, the arm 542 also stops. When the trigger 514 moves counterclockwise and stops at the operational position, the engaging unit 567 of the pin 562 is positioned between the end of the stopper 569 and the free end 544 of the arm 542 in the direction of the centerline 5A3.

In the manner, in the course of the counterclockwise movement of the trigger 514, the moving force of the arm 542 is transferred to the plunger 547. The plunger 547 moves from the initial position against the urging force of the urging member 550, so that the trigger valve 546 is in the moving state. In the manner, in cooperation with the trigger 514, the arm 542 transfers the moving force to the plunger 547.

When the trigger valve 564 is in the moving state, the pressure accumulating chamber 521 is disconnected from the path 553 while the path 553 and the gas-exhaust path 554 are connected to each other. Therefore, the compressed air of the control chamber 524 is exhausted to the outside B1 through the path 555, the path 553 and the gas-exhaust path 554, so that the pressure of the control chamber 524 becomes the same as the atmospheric pressure.

When the pressure of the control chamber 524 is the same as the atmospheric pressure, the head valve 522 is moved against the urging force of the urging member 525 by the pressure of the pressure accumulating chamber 521. Therefore, the head valve 522 disconnects the piston upper chamber 532 from the gas-exhaust path 523 while opening the port 528. In other words, the pressure accumulating chamber 521 and the piston upper chamber 532 are connected to each other, so that a pressure of the piston upper chamber 532 increases. When the pressure of the piston upper chamber 532 is higher than a pressure of the piston lower chamber 535, the striking unit 513 moves from the top dead center to the bottom dead center in the direction of the centerline 5A3, and the driver blade 530 strikes a nail 557 of an injection path 556. The struck nail 557 is impacted into the workpiece 581.

After the striking unit 513 impacts the nail 557 into the workpiece 581, the piston 529 collides with the bumper 533, and the bumper 533 absorbs a part of kinetic energy of the striking unit 513. A position of the striking unit 513 at the time of the collision of the piston 529 with the bumper 533 is the bottom dead center. During the movement of the striking unit 513 from the top dead center to the bottom dead center, the non-return valve 539 opens the path 536, and the compressed air of the piston lower chamber 535 flows from the path 536 to the return air chamber 538.

After the striking unit 513 strikes the nail 557, the operator brings the push lever 516 away from the workpiece 581 while releasing the operational force from the trigger 514. Then, the pin 562 is moved in a direction of going away from the plunger 547 by the urging force of the urging member 545. Then, the pin 562 is moved in the state with the engaging unit 567 being in contact with the end of the stopper 569 and with the stopper 569 being pressed against the electromagnet 570, or the pin 562 is moved in the state with the stopper 569 moving clockwise against the urging force of the urging member 571 so that the stopper 569 is away from the electromagnet 570, and then, the pin 562 and the stopper 569 stop at the initial position shown in FIG. 23.

Further, the state of the trigger valve 546 returns from the moving state to the initial state, the head valve 522 closes the port 528, and the piston upper chamber 532 and the gas-exhaust path 523 are connected to each other. Then, the pressure of the piston upper chamber 532 becomes the same as the atmospheric pressure, and the piston 529 is moved from the bottom dead center to the top dead center by the pressure of the piston lower chamber 535. The compressed air of the return air chamber 538 flows in the piston lower chamber 535 through the path 537, and the striking unit 513 returns to and stops at the top dead center.

(Example of Selection of Second Mode)

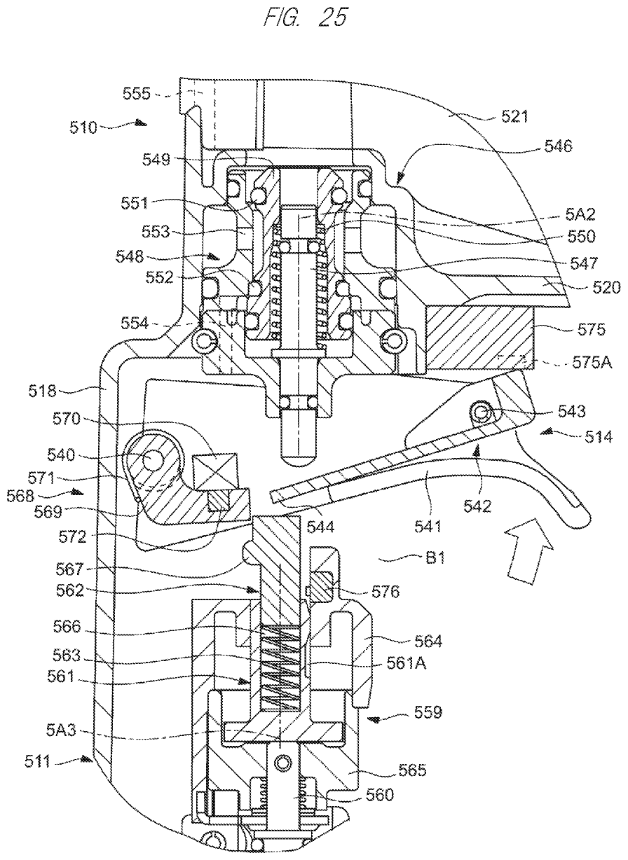

When the operator selects the second mode by operating the mode selecting member 573, the power supply switch 574 is tuned ON, and the control unit 577 is activated. In a state with the trigger 514 stopping at the initial position as shown in FIG. 23 and with the pin 562 stopping at the initial position, the operator applies the operational force onto the trigger 514 while bring the push lever 516 away from the workpiece 581, moves the trigger 514 counterclockwise in FIG. 23, and stops the trigger 514 at the operational position. Then, the stopper 569 moves counterclockwise in FIG. 23 together with the trigger 514, and stops at the operational position shown in FIG. 25 together with the trigger 514. When the stopper 569 stops at the operational position, the end of the stopper 569 is positioned within the moving region of the engaging unit 567. The arm 542 goes away from the pin 562, and then, is in contact with the stopper 541, and stops.

Meanwhile, when the control unit 577 detects the application of the operational force onto the trigger 514 on the basis of the signal of the trigger sensor 575, the control unit supplies the electric power to the electromagnet 570, and starts the counting of the elapsed time. When the elapsed time is within the predetermined time, the control unit 577 supplies the electric power to the electromagnet 570. When the electromagnet 570 generates the magnetic force, the stopper 569 moves clockwise as shown in FIG. 26 against the urging force of the urging member 571, and the end of the stopper 569 stops out of the moving region of the engaging unit 567.

When the elapsed time is within the predetermined time, if the push lever 516 is pressed against the workpiece 581, the push lever sensor 576 is turned ON. The cylinder 561 and the pin 562 move from the initial position in a direction of going close to the plunger 547, and the cylinder 561 and the pin 562 stop at the operational position. When the cylinder 561 reaches the operational position, the push lever sensor 576 is turned OFF, and the control unit 577 stops supplying the electric power to the electromagnet 570. Therefore, the stopper 569 returns to and stops at the initial position.

The moving force of the pin 562 is transferred to the plunger 547 through the arm 542. Therefore, the state of the trigger valve 546 is switched from the initial state shown in FIG. 26 to a moving state shown in FIG. 27. Therefore, the striking unit 513 moves from the top dead center to the bottom dead center, and the striking unit 513 impacts the nail 557 into the workpiece 581.

On the other hand, when the elapsed time exceeds the predetermined time in a state without the pressing of the push lever 516 against the workpiece 581, the control unit 577 stops supplying the electric power to the electromagnet 570, and resets the elapsed time. In other words, the stopper 569 stops at the initial position shown in FIG. 25. When the trigger 514 is at the operational position while the stopper 569 stops at the initial position, the end of the stopper 569 is positioned within the moving range of the engaging unit 567.

Therefore, when the push lever 516 is pressed against the workpiece 581 after the elapsed time exceeds the predetermined time, the end of the stopper 569 engages with the engaging unit 567. In other words, the stopper 569 blocks the transfer of the moving force of the push lever 516 to the plunger 547. Therefore, the trigger valve 546 is maintained in the initial state, and the striking unit 513 stops at the initial position.

In the manner, in cooperation with the application of the operational force onto the trigger 514 by the operator, the stopper 569 can block the transfer of the moving force of the push lever 516 to the trigger valve 546. Only within the predetermined time from the moment of the application of the operational force onto the trigger 514, the electric power is supplied to the electromagnet 570. Therefore, power consumption of the power supply 578 can be reduced as much as possible. The electric power is not supplied to the control unit 577 when the operator selects the first mode, and the electric power is supplied to the control unit 577 when the operator selects the second mode. Therefore, the power consumption of the power supply 578 can be reduced as much as possible.

Further, the operator selects the first mode when the electric power cannot be supplied from the power supply 578 to the electromagnet 570, such as when the voltage of the power supply 578 is lowered. Then, when the push lever 516 is pressed against the workpiece 581, the stopper 569 does not block the movement of the pin 562, and thus, the pin 562 can move from the initial position to the operational position. Therefore, the striking unit 513 can be moved from the top dead center to the bottom dead center.

Further, the urging member 563 is arranged between the cylinder 561 and the pin 562. When a metallic spring is used as the urging member 563, if the pressing force of the engaging unit 567 against the stopper 569 is too large, the spring elastically deforms, so that the load on the stopper 569 can be reduced. Therefore, the load on the prevention member 568 can be reduced.

(Second Control Example)

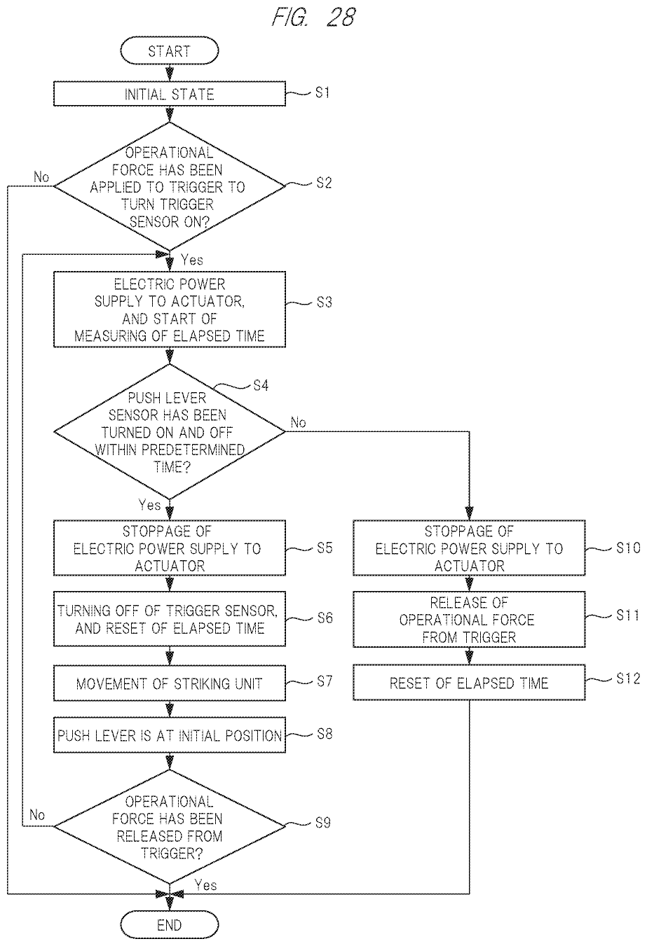

FIG. 28 is a flowchart showing a second control example that can be performed by the control unit 577. Note that the illustration of FIG. 28 includes other matters than the operations performed by the operator and the controls performed in the control unit 577. At a step S1, the driving tool 510 is in the initial state. The initial state of the driving tool 510 means that the operational force is released from the trigger 514, that the push lever 516 is away from the workpiece 581, and that the supply of the electric power to the actuator 580 stops.

The control unit 577 determines whether or not the operational force has been applied to the trigger 514 at the step S2 to turn the trigger sensor 575 ON. The trigger sensor 575 is turned ON when the arm 542 that moves counterclockwise around the pin 562 as the pivot point pushes the contactor 575A. When the control unit 577 determines its result as “No” at the step S2, the control unit ends the second control example in FIG. 28. When the control unit 577 determines its result as “Yes” at the step S2, the control unit supplies the electric power to the actuator 580 at a step S3, and starts to count the elapsed time.

At a step S4, the control unit 577 determines whether or not the push lever sensor 576 has been turned ON and OFF within the predetermined time from the moment of the start of the counting of the elapsed time. When the control unit 577 determines its result as “Yes” at the step S4, the control unit determines that the push lever 516 has reached the operational position, and stops the electric power supply to the actuator 580 at a step S5.

When the push lever 516 is moved so that the pin 562 reaches the operational position in the state with the trigger 514 stopping at the operational position, the state of the trigger sensor 575 is switched from the ON state to the OFF state at a step S6. When the trigger sensor 575 is turned OFF, the control unit 577 resets the elapsed time at the step S6.

In the manner, when the operational force is applied onto the trigger 514 while the push lever 516 is pressed against the workpiece 581, the state of the trigger valve 546 is switched from the initial state to the moving state, and the striking unit 513 moves from the top dead center to the bottom dead center at a step S7.

After the striking unit 513 moves from the top dead center to the bottom dead center, the operator brings the push lever 516 away from the workpiece 581. The control unit 577 detects that the push lever 516 is returned to the initial position at a step S8. The control unit 577 determines whether or not the operational force has been released from the trigger 514 at a step S9. When the push lever 516 stops at the initial position while the trigger sensor 575 is turned OFF, the control unit 577 determines that the operational force has been released from the trigger 514. The determination of the result as “No” made by the control unit 577 in the step S9 means that the operator's will is to continue the striking operation in the second mode, and therefore, the control unit 577 advances the process to the step S3.

On the other hand, when the control unit 577 determines the result as “Yes” at the step S9, the second control example in FIG. 28 ends. When the control unit 577 determines the result as “No” at the step S4, the control unit stops supplying the electric power to the actuator 580 at a step S10. Therefore, the stopper 569 is maintained at the initial position as shown in FIG. 25. In other words, even when the push lever 516 is pressed against the workpiece 581, the striking unit 513 stops at the top dead center. Further, when the operator releases the operational force from the trigger 514 at a step S11, the control unit 577 resets the elapsed time at a step S12, and the second control example in FIG. 28 ends.

(Third Control Example)

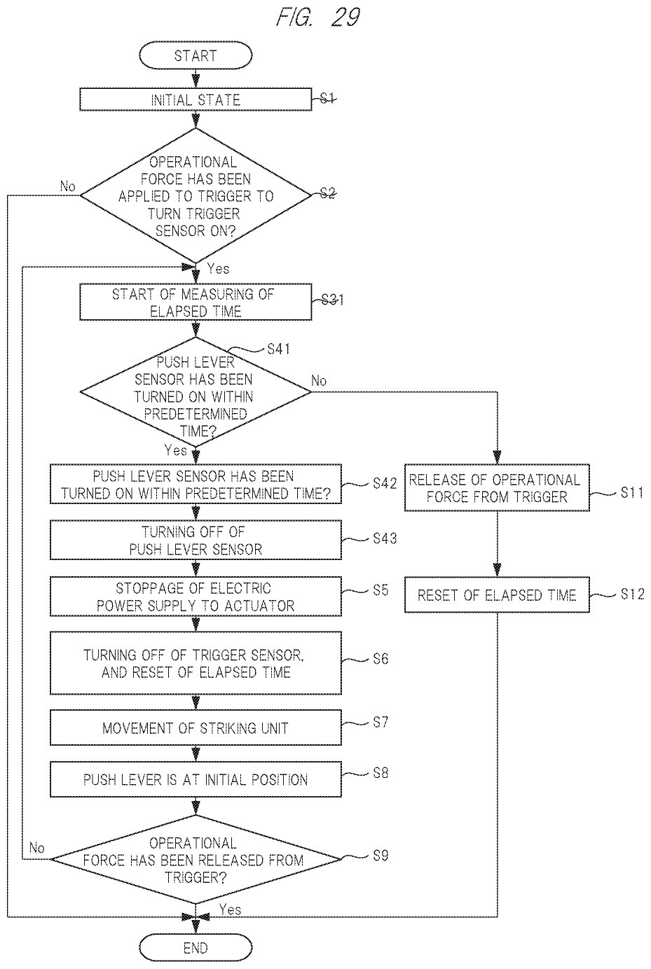

FIG. 29 is a flowchart showing a third control example that can be performed in the control unit 577. Note that the illustration of FIG. 29 includes other matters than the operations performed by the operator and the controls performed in the control unit 577. When operations or determinations at steps shown in FIG. 29 and the operations or the determinations at the steps shown in FIG. 28 are the same as each other, the same step symbols as those of FIG. 28 are attached.

When the control unit 577 determines the result as “Yes” at a step S2 in FIG. 29, the control unit 577 at a step S31 starts to count the elapsed time from a moment at which the trigger sensor 575 is turned ON. At a step S41, the control unit 577 determines whether or not the push lever sensor 576 has been turned ON within predetermined time from a moment of the start of the counting of the elapsed time. When the control unit 577 determines the result as “Yes” at the step S41, the control unit supplies the electric power to the actuator 580 at a step S42.

When the control unit 577 detects the turning OFF of the push lever sensor at a step S43, the control unit determines that the pin 562 has reached the operational position in FIG. 27, stops supplying the electric power to the actuator 580 in the step S5, and advances the process to the step S6.

After the control unit 577 determines the result as “No” at the step S41, the operator performs the operation of the step S11. Then, the control unit 577 resets the elapsed time at the step S12, and the third control example in FIG. 29 ends. When the control unit 577 performs the third control example in FIG. 29, the electric power consumption of the power supply 578 can be reduced.

Further, an urging member 563 is arranged in a moving-force transfer path between the push lever 516 and the pin 562. When the urging member 563 is a buffer member such as a metallic spring or a synthetic rubber spring, the urging member 563 can absorb or moderate a part of impact in a state with the stopper 569 preventing the movement of the pin 562, the impact being caused when the push lever 516 is in contact with an object while.

Still further, the trigger sensor 575 is turned ON or OFF when the arm 542 attached to the trigger 514 pushes the contactor 575A of the trigger sensor 575 or when the arm 542 is away from the contactor 575A. Therefore, the control unit 577 can detect a first state and a second state through the signals from the single trigger sensor 575 and can perform the corresponding control, the first state resetting the elapsed time due to the release of the operational force from the trigger 514 when the push lever 516 has not been pressed against the workpiece 581 within the predetermined time from the moment of the application of the operational force onto the trigger 514, and the second state moving the striking unit 513 from the top dead center to the bottom dead center due to the pressing of the push lever 516 against the workpiece 581 within the predetermined time from the moment of the operational force onto the trigger 514 while resetting the elapsed time. Note that the second state includes a state right before the movement of the striking unit 513 from the top dead center to the bottom dead center.

Therefore, in comparison between the present embodiment and a case of a driving tool having a sensor or a switch for use in detecting the first state and the second state, the number of components can be reduced in the present embodiment. When the number of components is reduced in a nail driving tool that is configured so that the compressed air is supplied from outside of a main body into a pressure accumulating chamber, a weight of the main body can be suppressed from increasing, and a size of a mechanism can be suppressed from increasing, and therefore, the present embodiment is particularly effect.

### Sixth Embodiment

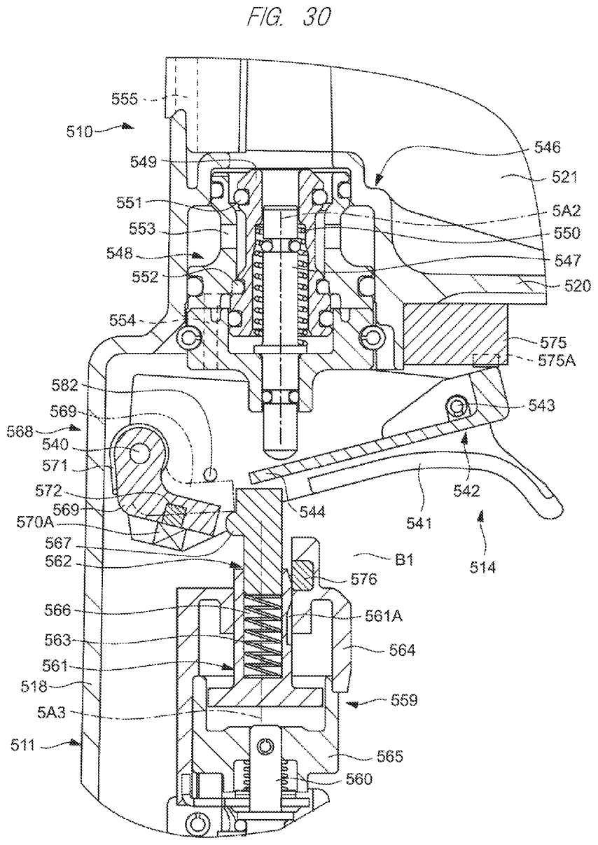

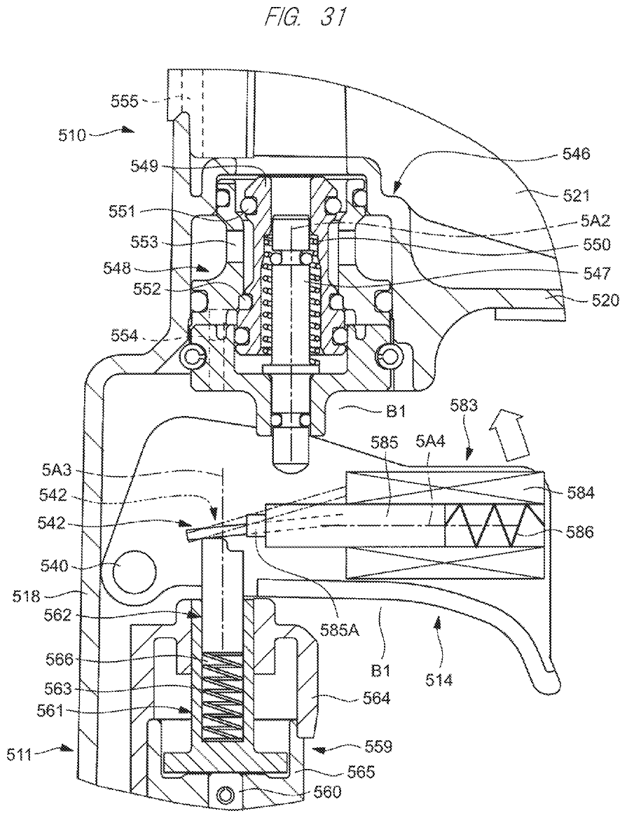

A sixth embodiment of the driving tool 510 is shown in FIG. 30. The same structure of the driving tool 510 shown in FIG. 30 as the structure shown in FIG. 22 is denoted with the same symbols as the symbols shown in FIG. 22. A stopper 569 is urged counterclockwise in FIG. 30 by an urging member 571. The trigger 514 is provided with a pin 582. The trigger 514 is provided with an electromagnet 570A. The electromagnet 570A is different from the permanent magnet 572 in a polar character in the electric power supply. When the supply of the electric power to the electromagnet 570A stops, the stopper 569 that is urged by the urging member 571 is in contact with the pin 582, and then, stops at an initial position shown with a dashed double-dotted line. When the electromagnet 570A generates a magnetic force by the supply of the electric power to the electromagnet 570A, the stopper 569 moves clockwise against the urging force of the urging member 571, is in contact with the electromagnet 570A, and then, stops at an operational position shown with a solid line. The driving tool 510 in FIG. 30 has the control system shown in FIG. 24. The electromagnet 570A is one example of the actuator 580.

Next, a usage example of the driving tool 510 in FIG. 30 will be explained. When the operator selects the first mode, the supply of the electric power to the electromagnet 570A stops. In a state with the trigger 514 stopping at the initial position, an end of the stopper 569 is positioned out of the moving range of the engaging unit 567.

The pin 562 is movable when the trigger 514 is in the initial state while the operator brings the push lever 516 into contact with the workpiece 581 and moves the push lever 516 from the initial position. Therefore, the state of the trigger valve 546 is switched from the initial state to the moving state, and the striking unit 513 moves from the top dead center to the bottom dead center. In the course between the going away of the push lever 516 from the workpiece 581 and the return of the pin 562 from the operational position to the initial position, the movement of the pin 562 is not blocked by the stopper 569. A principle of this is the same as that of the fifth embodiment of the driving tool 510.

Next, when the operator selects the second mode in the driving tool 510 shown in FIG. 30, the control unit 577 can perform the second control example in FIG. 28 or the third control example in FIG. 29. When the control unit 577 supplies the electric power to the electromagnet 570A at the step S3 of FIG. 28, the stopper 569 moves from the initial position shown with the dashed double-dotted line to the operational position shown with the solid line, and stops at the operational position. When the stopper 569 stops at the operational position, the stopper 569 is positioned out of the moving range of the engaging unit 567. Therefore, when the push lever 516 is pressed against the workpiece 581 and moves, the stopper 569 does not block the movement of the pin 562. Therefore, the state of the trigger valve 546 is switched from the initial state to the moving state, and the striking unit 513 moves from the top dead center to the bottom dead center.

When the control unit 577 stops supplying the electric power to the electromagnet 570A at the step S5 of FIG. 28, the stopper 569 stops at the initial position at which the stopper is in contact with the pin 582. Next, when the operator brings the push lever 516 away from the workpiece 581, the stopper 569 moves clockwise in the course of the return of the pin 562 from the operational position to the initial position, and therefore, the stopper 569 does not block the movement of the pin 562. A principle of this is the same as that of the fifth embodiment of the driving tool 510.

The control unit 577 stops supplying the electric power to the electromagnet 570A at the step S10. Then, the end of the stopper 569 that is in contact with the pin 582 is positioned within the moving range of the engaging unit 567. Therefore, when the push lever 516 is pressed against the workpiece 581 after the elapsed time from the moment of the application of the operational force onto the trigger 514 exceeds the predetermined time, the trigger valve 546 is maintained in the initial state because of the same principle as that of the fifth embodiment of the driving tool 510.

Further, when the control unit 577 performs the third control example of FIG. 29, the control unit 577 supplies the electric power to the electromagnet 570A at a step S42. Then, the stopper 569 moves from the initial position shown with the dashed double-dotted line to the operational position shown with the solid line, and stops at the operational position. When the control unit 577 stops supplying the electric power to the electromagnet 570A at a step S5 of FIG. 29, the stopper 569 stops at the initial position at which the stopper is in contact with the pin 582 as shown with a dashed double-dotted line in FIG. 30. By the sixth embodiment of the driving tool 510, the same effect as that of the fifth embodiment of the driving tool 510 can be obtained.

### Seventh Embodiment

A seventh embodiment of the driving tool 510 is shown in FIG. 31. The trigger 514 is provided with a solenoid 583 serving as a prevention mechanism. The solenoid 583 has a function of blocking the transfer of the moving force of the push lever 516, more specifically, the moving force of the pin 562, to the plunger 547. The solenoid 583 includes a coil 584, a plunger 585 and an urging member 586. The plunger 585 is made of a magnetic material, and is movable in a direction of a centerline 5A4. The centerline 5A4 crosses the centerline 5A3. One example of the urging member 586 is a metallic spring. The plunger 585 is urged in a direction of going close to the pin 562 by the urging force of the urging member 586, and stops at an initial position. The coil 584 to which the electric power is supplied generates a magnetic force, and urges the plunger 585 in a direction of going away from the pin 562, and then, the plunger 585 stops at the operational position. The seventh embodiment of the driving tool 510 includes the control system of FIG. 24. The solenoid 583 is one example of the actuator 580. The arm 542 is urged counterclockwise in FIG. 31, and the trigger 514 is urged clockwise in FIG. 31.

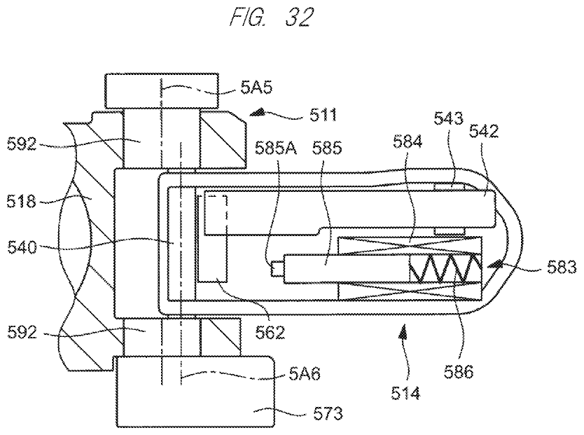

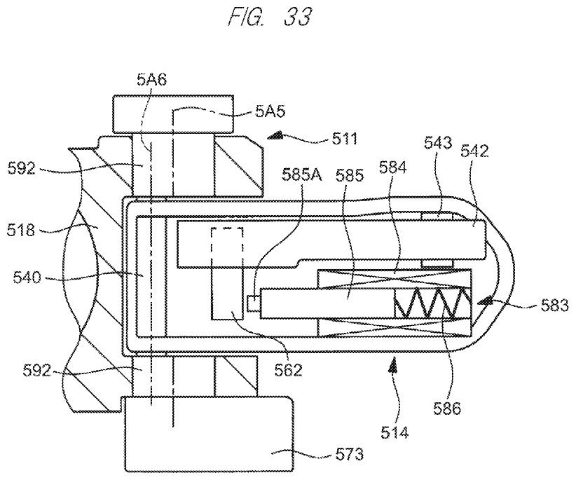

Further, as shown in FIGS. 32 and 33, the trigger 514 is supported by the main body 511 through amain shaft 592 and a support shaft 540. The main shaft 592 has a columnar shape, and the main shaft 592 is rotatable around the centerline 5A5 serving as its center. A mode selecting member 573 is attached to the main shaft 592. The support shaft 540 is arranged so as to put a centerline 5A6 as its center, the centerline 5A6 being eccentrically arranged from the centerline 5A5 of the main shaft 592. When the operator operates the mode selecting member 573, the main shaft 592 rotates, and the main shaft 592 can stop at the position corresponding to the first mode or the second mode.

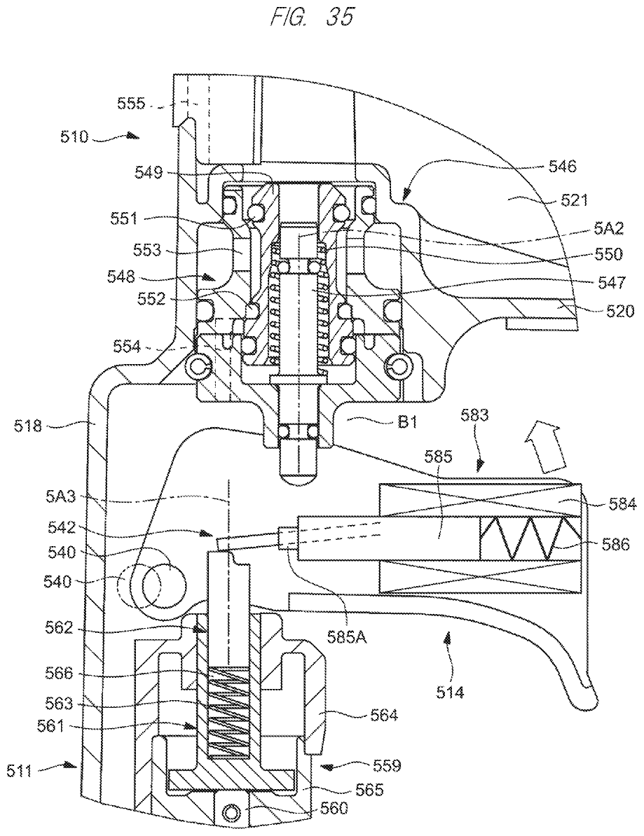

In the state with the plunger 585 stopping at the initial position, a distance between the plunger 585 and the pin 562 in a case of selection of the first mode by the operator is larger than a distance between the plunger 585 and the pin 562 in a case of selection of the second mode by the operator. FIGS. 32 and 35 show a position of the plunger 585 in the case of the selection of the first mode. FIGS. 31, 33 and 34 show a position of the plunger 585 in the case of the selection of the second mode. Other structures of the seventh embodiment of the driving tool 510 are the same as other structures of the fifth embodiment of the driving tool 510.

(Example of Selection of First Mode)

When the operator selects the first mode in the seventh embodiment of the driving tool 510, the control unit 577 stops since the electric power is not supplied to the control unit 577 shown in FIG. 24. When the operator selects the first mode, the plunger 585 stops at the initial position since the electric power is not supplied to the solenoid 583. The plunger 585 is positioned out of the moving range of the pin 562.

When the operator selects the first mode and presses the push lever 516 against the workpiece 581, the pin 562 moves, and the arm 542 moves. Next, when the operator applies the operational force onto the trigger 514, the state of the trigger valve 546 is switched from the initial state to the moving state. Therefore, the striking unit 513 moves from the top dead center to the bottom dead center.

Then, when the operator releases the operational force from the trigger 514 while the operator brings the push lever 516 away from the workpiece 581, the state of the trigger valve 546 returns from the moving state to the initial state. The plunger 585 is not in contact with the pin 562 when the operator releases the operational force from the trigger 514 while brings the push lever 516 away from the workpiece 581 to return the pin 562 from the operational position to the initial position.

(Example of Selection of Second Mode)

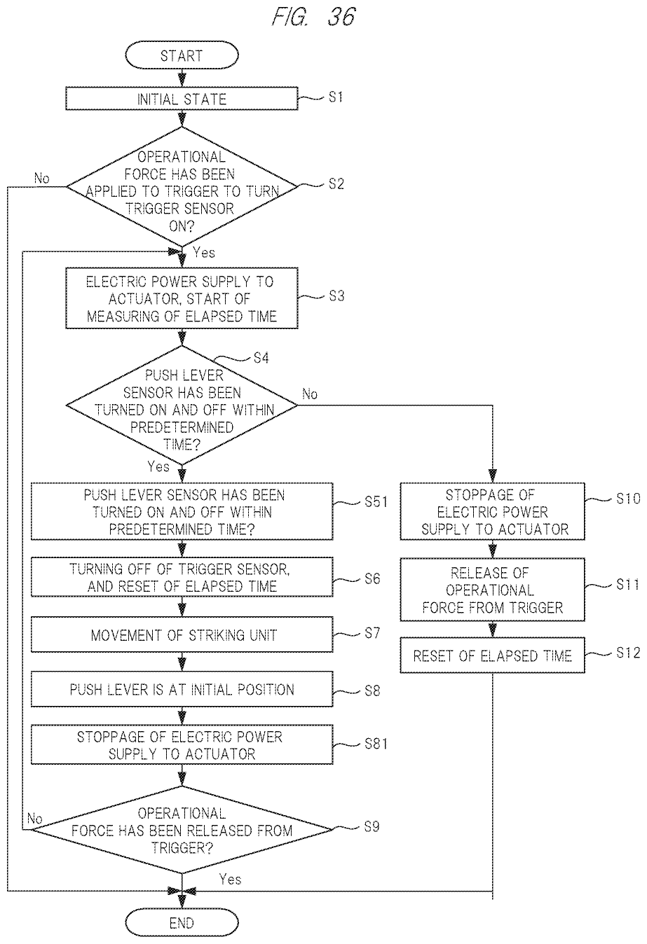

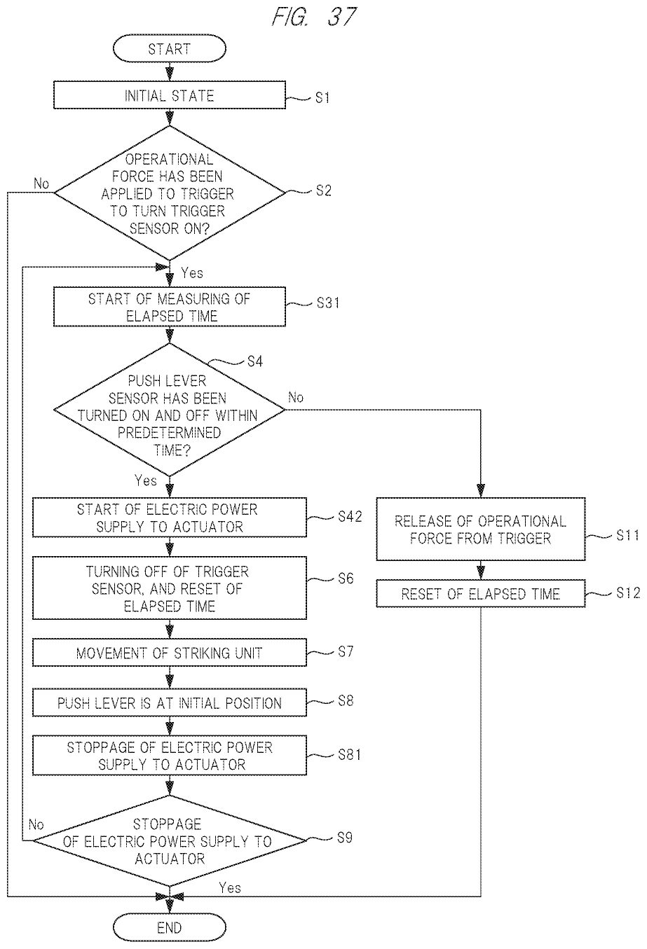

When the operator selects the second mode in the seventh embodiment of the driving tool 510, the control unit 577 is activated since the electric power is supplied to the control unit 577 shown in FIG. 24, so that the fourth control example in FIG. 36 or the fifth control example in FIG. 37 can be performed.

First, the fourth control example in FIG. 36 will be explained. The same processes and determinations in FIG. 36 as those of the second control example in FIG. 28 are denoted with the same step symbols as those of FIG. 28.

When the operator applies the operational force onto the trigger 514, the control unit 577 determines the result as “Yes” at the step S2, the control unit 577 starts to count the elapsed time at at the step S3, and supplies the electric power to the solenoid 583. Therefore, an end 585A of the plunger 585 moves to outside of the moving range of the pin 562 and stops. The arm 542 moves from the initial position shown with the solid line to the middle position shown with the dashed double-dotted line in FIG. 31.

After the control unit 577 determines the result as “Yes” at the step S4, the control unit 577 continues to supply the electric power to the solenoid 583 at a step S51. At the step S7, the striking unit 513 moves from the top dead center to the bottom dead center.

Then, when the push lever sensor 576 is turned OFF by the return of the push lever 516 to the initial position at the step S8, the control unit 577 stops supplying the electric power to the solenoid 583 at a step S81, and performs the determination of the step S9.

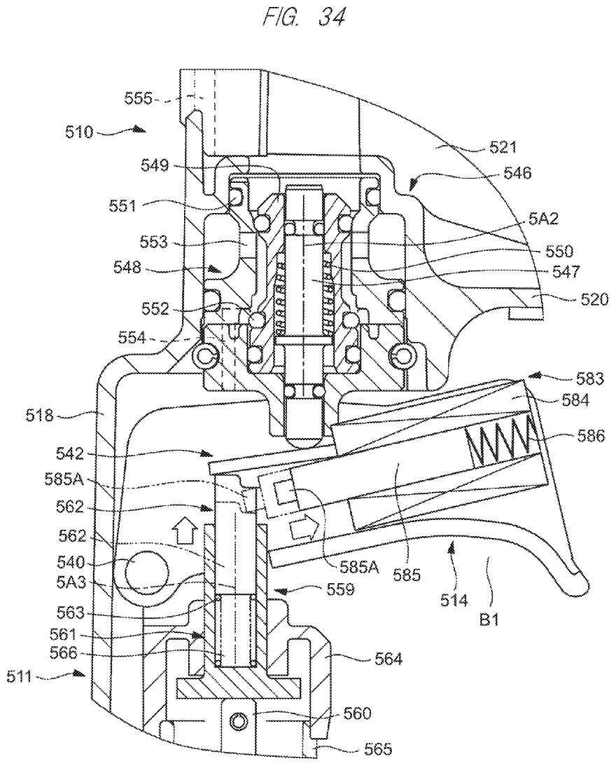

When the control unit 577 determines the result as “No” at the step S4, the control unit 577 stops supplying the electric power to the solenoid 583 at the step S10. When the operator releases the operational force from the trigger 514 at the step S11, the control unit 577 resets the elapsed time at the step S12, and ends the fourth control example of FIG. 36. Therefore, when the push lever 516 moves at the moment exceeding the predetermined time from the moment at which the trigger sensor 575 is turned ON by the application of the operational force onto the trigger 514, the end 585A of the plunger 585 blocks the movement of the pin 562 as shown with the dashed double-dotted line in FIG. 34. Therefore, the trigger valve 546 is maintained in the initial state.

Next, A fifth control example of FIG. 37 will be explained. The same processes and determinations in FIG. 37 as those of the third control example in FIG. 29 are denoted with the same step symbols as those of FIG. 29.

When the control unit 577 determines the result as “Yes” at the step S2, the control unit 577 starts to count the elapsed time at the step S31. Further, when the control unit 577 determines the result as “Yes” at the step S4, the control unit starts to supply the electric power to the solenoid 583 at the step S42. And, the control unit 577 performs the processes of the steps S6 to S9.

When the control unit 577 determines the result as “No” at the step S4, the operator releases the operational force from the trigger 514 at the step S11. And, the control unit 577 resets the elapsed time at the step S12, and ends the fifth control example of FIG. 37. In other words, the plunger 585 is maintained at the initial position as shown with the dashed double-dotted line in FIG.

34.

Therefore, when the push lever 516 moves at the moment exceeding the predetermined time from the moment at which the trigger sensor 575 is turned ON by the application of the operational force onto the trigger 514, the end 585A of the plunger 585 blocks the movement of the pin 562 as shown with the dashed double-dotted line in FIG. 34. Therefore, the trigger valve 546 is maintained in the initial state.

Further, the urging member 563 is arranged in the moving-force transfer path between the push lever 516 and the pin 562. The urging member 563 can absorb or moderate a part of the impact caused when the push lever 516 is in contact with an object. Therefore, the load on the solenoid 583 can be reduced.

### Eighth Embodiment

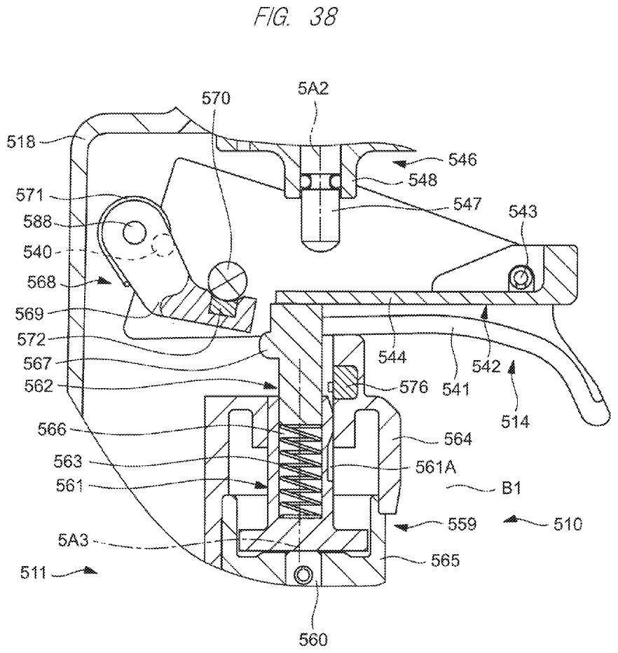

FIG. 38 is a partial cross-sectional view of an eighth embodiment of the driving tool 510. The stopper 569 is attached to the main body 511 so as to be movable around a support shaft 588 serving as its center. The support shaft 588 supporting the stopper 569 is a different member from the support shaft 540 supporting the trigger 514. Other structures in FIG. 38 are the same as other structures in FIG. 23. The control system in FIG. 24 can be used for the eighth embodiment of FIG. 38. In the eighth embodiment of the driving tool 510, the control example of FIG. 28 or 29 can be also used.

Technical implications of matters explained in the fifth to eighth embodiments are as follows. The driving tool 510 is one example of the driving tool. The trigger 514 is one example of the operational member, and the push lever 516 is one example of the contact member. The piston upper chamber 532 is one example of the pressure chamber. The striking unit 513 is one example of the striking unit. The rigger valve 546 is one example of the gas supplying mechanism. The pin 562 is one example of the transferring member. Each of the stopper 569 and the plunger 585 is one example of the prevention member. Each of the control unit 577, the electromagnets 570 and 570A and the coil 584 is one example of the driving unit. Each of the electromagnets 570 and 570A and the coil 584 is a magnetic-force forming element.

The state in which the end of the stopper 569 is positioned within the moving range of the engaging unit 567 is one example of the first position. The state in which the control unit 577 supplies the electric power to the electromagnets 570 and 570A so that the end of the stopper 569 is positioned within the moving range of the engaging unit 567 is one example of the prevention control. The state in which the end 585A of the plunger 585 is positioned within the moving range of the pin 562 is one example of the first position. The state in which the control unit 577 controls the solenoid 583 so that the end 585A of the plunger 585 is positioned within the moving range of the pin 562 is one example of the prevention control.

The state in which the end of the stopper 569 is positioned out of the moving range of the engaging unit 567 is one example of the second position. The state in which the control unit 577 stops supplying the electric power to the electromagnets 570 and 570A so that the end of the stopper 569 is positioned out of the moving range of the engaging unit 567 is one example of the releasing control. The state in which the end 585A of the plunger 585 is positioned out of the moving range of the pin 562 is one example of the second position. The state in which the control unit 577 controls the solenoid 583 so that the end 585A of the plunger 585 is positioned out of the moving range of the pin 562 is one example of the releasing control. The main body 511 is one example of the housing. The support shaft 540 is one example of the support shaft. The support shaft 540 is one example of the first support shaft, and the support shaft 588 is one example of the second support shaft. The mode selecting member 573 is one example of the mode selecting member. Each of the power supply switch 574 and the power supply 578 is one example of the power supply unit. The nail 557 is one example of the fastener. The urging member 563 is one example of the buffer member. The trigger sensor 575 is one example of the signal output unit.

A signal that is output from the trigger sensor 575 is one example of the first signal, the signal being output when the state of the trigger sensor 575 that is in the ON state of the first state is switched from the ON state to the OFF state by the pressing of the push lever 516 against the workpiece 581. An output signal is one example of the second signal, the output signal being output when the trigger sensor 575 is turned OFF by the movement of the trigger 514 from the operational position to the initial position in the state with the trigger sensor 575 being in the ON state because the trigger 514 stops at the operational position. The arm 542 is one example of the arm. The state in which the arm 542 pushes the contactor 575A is one example of the function of the arm onto the signal output unit.

The driving tool is not limited to the foregoing embodiments, and various modifications and alterations can be made within the scope of the present invention. For example, the operational member includes not only the element that rotates within the predetermined angle range by the application of the operational force thereon, but also an element that moves within a predetermined range by the application of the operational force thereon. Types of the operational member includes a lever, a knob, a button, an arm and others. The contact member is an element that is pressed against the workpiece and moves, and types of the same includes a lever, an arm, a rod, a plunger and others.

The control unit may be single electric or electronic component, or a unit having a plurality of electric or electronic components. Types of the electric or electronic component includes a processor, a control circuit and a module. Types of the gas supply mechanism include a switching valve that performs switching between the connection of the paths and the disconnection of the paths.

The housing is an element that supports the component element of the driving tool or a member connected to the element, and types of the housing include a case, a bracket and a shell. As the compressed gas, inert gas such as nitrogen gas or rare gas can be also used in place of the compressed air. The first mode can be defined as single shot, and the second mode can be defined as successive shot.

The trigger sensor 575 outputs a signal depending on the state of the trigger 514. Types of the state of the trigger 514 include existence of the operational force applied on the trigger 514, a moving angle of the trigger 514 from the initial position and others . The push lever sensor 576 outputs a signal depending on the state of the cylinder 561 to which the moving force of the push lever 516 is transferred and which moves. Types of the state of the cylinder 561 include existence of the moving force transferred to the cylinder 561, a moving amount of the cylinder 561 from the initial position and others. As each of the trigger sensor 575 and the push lever sensor 576, a contact sensor or a non-contact sensor can be used. One example of the contact sensor is a tactile switch. One example of the non-contact sensor is an optical sensor, a magnetic sensor or an infrared sensor. The signals of the trigger sensor 575 and the push lever sensor 576 are input to the control unit 577.

If the push lever sensor 576 can detect the moving amount of the cylinder 561, the control unit 577 can also stop supplying the electric power to the electromagnets 570 and 570A at a moment at which the cylinder 561 has moved by a predetermined amount from the initial position to the operational position at the step S5 of FIGS. 28 and 29. The predetermined amount has a value that prevents the stopper 569 from blocking the movement of the pin 562 when the supply of the electric power to the electromagnets 570 and 570A stops. Data of the predetermined amount has a value that is obtained by simulation or an experiment, and is previously stored in the control unit 577.

As a modification example of the prevention mechanism 568 shown in FIG. 23, the push lever 516 may be provided with the permanent magnet 572 while the stopper 569 may be provided with the electromagnet 570. As a modification example of the prevention mechanism 568 shown in FIG. 30, the push lever 516 may be provided with the permanent magnet 572 while the stopper 569 may be provided with the electromagnet 570A. The arm may be an element that is in contact with or away from the signal output unit and that can move and stop so as to output the signal from the signal output unit. In other words, the arm may be not limited to the one that is so-called arm but a lever.

### EXPLANATION OF REFERENCE CHARACTERS

10 . . . driving tool, 13 . . . striking unit, 15 . . . injection unit, 22 . . . head valve, 25 . . . control chamber, 29 . . . piston upper chamber, 30 . . . port, 51 . . . trigger valve, 60 . . . trigger, 67 . . . push lever, 78 . . . solenoid, 79 . . . moving member, 80 and 106 . . . stopper, 90 and 111 . . . urging member, 95 . . . control unit, 96 . . . power supply, 125 . . . exhaust port, 208 . . . rotary solenoid, C1 and C2 . . . gap, 510 . . . driving tool, 511 . . . main body, 513 . . . striking unit, 514 . . . trigger, 516 . . . push lever, 532 . . . piston upper chamber, 540 and 588 . . . support shaft, 542 . . . arm, 546 . . . trigger valve, 562 . . . pin, 563 . . . urging member, 569 . . . stopper, 570 and 570A . . . electromagnet, 573 . . . mode selecting member, 574 . . . power supply switch, 575 . . . trigger sensor, 577 . . . control unit, 578 . . . power supply, 584 . . . coil, 585 . . . plunger

1-16. (canceled)

17. A driving tool comprising:
a striking unit configured to strike a fastener;
an operational member configured to be operated by an operator for applying an operational force;
a contact member allowed to be in contact with and away from a workpiece and configured to move while being in contact with the workpiece;
a switching mechanism capable of performing switching between a first state allowing the driving tool to perform impacting by transferring movement force of the contact member and a second state preventing the driving tool from performing impacting by preventing the transfer of the movement force of the contact member;
a first mode in which the driving tool is driven by causing the operator to operate the operational member in a state with movement of the contact member; and
a second mode in which the driving tool is driven by the movement of the contact member in a state with the operator operating the operational member,
wherein in the second mode, the switching mechanism is brought in the second state when electric power is not supplied, and the switching mechanism is brought in the first state when the electric power is supplied.

18. A driving tool comprising:
a striking unit configured to strike a fastener;
an operational member configured to be operated by an operator for applying an operational force;
a contact member allowed to be in contact with and away from a workpiece and configured to move while being in contact with the workpiece;
a switching mechanism capable of performing switching between a first state allowing the driving tool to perform impacting by transferring movement force of the contact member and a second state preventing the driving tool from performing impacting by preventing the transfer of the movement force of the contact member;
a first mode in which the driving tool is driven by causing the operator to perform operation in a state with movement of the contact member; and
a second mode in which the driving tool is driven by the movement of the contact member in a state with the operator operating the operational member,
wherein when the second mode is selected, if a state with the operator operating the operational member and with the contact member being away from the workpiece is within predetermined time, electric power is supplied to the switching mechanism so that the switching mechanism becomes in the first state,
when the second mode is selected, if the state with the operator operating the operational member and with the contact member being away from the workpiece exceeds the predetermined time, the supply of the electric power to the switching mechanism stops so that the switching mechanism becomes in the second state, and
when the first mode is selected, the electric power to the switching mechanism is not supplied, and the switching mechanism is brought in the first state.

19. The driving tool according to claim 18 further comprising
a mode selecting member allowed to be operated by the operator, and configured to control driving of the striking unit,
wherein when the first mode is selected, the switching mechanism is brought in the first state by the operational force on the mode selecting member.

20. The driving tool according to claim 19, wherein the mode selecting member has a first operational position corresponding to the first mode and a second operational position corresponding to the second mode.

21. The driving tool according to claim 17 further comprising:
a pressure chamber to which/from which compressed gas is supplied/exhausted;
the striking unit configured to move when the compressed gas is supplied to the pressure chamber; and
a driving unit having a supply state in which the compressed gas is supplied to the pressure chamber and an exhaust state in which the compressed gas is exhausted from the pressure chamber,
wherein the driving unit includes:
a supply port configured to supply the compressed gas to the pressure chamber;
an exhaust port configured to exhaust the compressed gas from the pressure chamber; and
a valve configured to open and close each of the supply port and the exhaust port,
the supply state is a state in which the valve opens the supply port and closes the exhaust port, and
the exhaust state is a state in which the valve closes the supply port and opens the exhaust port.

22. The driving tool according to claim 18 further comprising:
a power supply capable of supplying electric power to the switching mechanism; and
a control unit configured to control supply and stoppage of the supply of the electric power to the switching mechanism.

23. The driving tool according to claim 22,
wherein the switching mechanism includes:
a release mechanism configured to supply and stop supplying the electric power; and
a prevention member connected to the release mechanism so that a moving force can be transferred thereto,
the contact member moves in a predetermined moving range when being in contact with the workpiece,
the first state is a state in which the prevention member stops out of the moving range, and
the second state is a state in which movement of the contact member is blocked since the prevention member stops within the moving range.

24. The driving tool according to claim 23 further comprising
a maintaining mechanism configured to stop the prevention member within the moving range,
wherein the first state is a state in which the prevention member stops out of the moving range when the electric power is supplied to the release mechanism, and
the second state is a state in which the prevention member stops within the moving range when the supply of the electric power to the release mechanism stops.

25. The driving tool according to claim 24 further comprising
a control unit configured to supply and stop supplying the electric power to the release mechanism,
wherein the control unit supplies the electric power to the release mechanism from a moment at which the operator selects the second mode by operating the mode selecting member and operates the operational member.

26. The driving tool according to claim 18 further comprising:
a prevention member configured to be movable within and out of a moving range of a transfer member arranged in the contact member and configured to have a first position at which the prevention member is positioned within the moving range of the transfer member when the operational force is applied onto the operational member in the second state, and a second position at which the prevention member is positioned out of the moving range of the transfer member when the operational force is released from the operational member in the first state; and
a driving unit configured to allow a state of the prevention member to be switched between the first position and the second position when the operational force is applied onto the operational member,
wherein in a case of selection of the second mode,
when the prevention member is at the first position after the operational force is applied onto the operational member, if the contact member is moved within predetermined time from a moment of the application of the operational force onto the operational member, the driving unit performs release control that brings the prevention member to the second position so that the contact member is in a movable state,
when the prevention member is at the first position after the operational force is applied onto the operational member, if time for no movement of the contact member exceeds the predetermined time from the moment of the application of the operational force onto the operational member, the driving unit performs prevention control that maintains the prevention member at the first position so that the contact member is in an unmovable state.

27. The driving tool according to claim 26,
wherein at least either the prevention member or the driving unit includes a magnetic-force forming element configured to form a magnetic force when the electric power is supplied to itself, and
the driving unit switches a state of the prevention member between the first position and the second position by controlling the supply of the electric power and the stoppage of the supply to the magnetic-force forming element.

28. The driving tool according to claim 26 further comprising:
a housing to which the operational member is attached; and
a support shaft arranged in the housing,
wherein the support shaft supports the operational member so as to be movable, and supports the prevention member so as to be movable.

29. The driving tool according to claim 26,
wherein a first support shaft configured to support the operational member so as to be rotatable and a second support shaft configured to support the prevention member so as to be movable are separately arranged.

30. The driving tool according to claim 26,
wherein the driving unit is activated when the electric power is supplied to itself,
modes in which the operator applies the operational force onto the operational member and brings and moves the contact member in contact with the workpiece include:
a first mode configured to apply the operational force onto the operational member in a state with the contact member being in contact with the workpiece; and
a second mode configured to bring the contact member into contact with the workpiece in a state with application of the operational force onto the operational member,
a power supply unit configured to supply and stop the supply of the electric power to the driving unit is arranged,
the power supply unit stops supplying the electric power to the driving unit when the operator selects the first mode by operating the mode selecting member, and
the power supply unit supplies the electric power to the driving unit when the operator selects the second mode by operating the mode selecting member.

31. The driving tool according to claim 26 further comprising
a signal output unit configured to output a first signal when the contact member moves in a state with the application of the operational force onto the operational member and output a second signal when the operational force is released from the operational member,
wherein the driving unit performs
control for starting counting of elapsed time from a moment of the application of the operational force onto the operational member, and
control for resetting the counted elapsed time when at least either the first signal or the second signal is output from the signal output unit.

32. The driving tool according to claim 31,
wherein the operational member includes an arm configured to transfer a moving force to the gas supply mechanism in cooperation with the contact member,
the arm has:
a first state in which the arm performs a function to the signal output unit in a state with application of the operational force onto the operational member and with the contact member being away from the workpiece; and
a second state in which the arm performs a function to the signal output unit when the contact member is moved while being in contact with the workpiece in the state with the application of the operational force onto the operational member or when the operational force is released from the operational member in the state with the application of the operational force onto the operational member, and
the first signal and the second signal are output from the signal output unit when the arm is the second state.

33. A driving tool comprising:
an operational member configured to be operated by an operator for applying an operational force;
a contact member allowed to be in contact with and away from a workpiece and configured to move while being in contact with the workpiece;
a switching mechanism capable of performing switching between a first state transferring movement force of the contact member and a second state preventing the transfer of the movement force of the contact member;
a striking unit configured to strike a fastener; and
a mode selecting member allowed to be operated by the operator, and configured to control driving of the striking unit,
wherein the mode selecting member has:
a first mode allowing the driving tool to perform operation when the operator operates the operational member in a state with movement of the contact member; and
a second mode allowing the driving tool to perform operation when the contact member is moved while the operation member is operated, regardless of an order of the movement of the contact member and the operation of the operational member,
when the second mode is selected, if a state with the operator operating the operational member and with the contact member being away from the workpiece is within predetermined time, electric power is supplied to the switching mechanism so that the switching mechanism becomes in the first state,
when the second mode is selected, if the state with the operator operating the operational member and with the contact member being away from the workpiece exceeds the predetermined time, the supply of the electric power to the switching mechanism stops so that the switching mechanism becomes in the second state,
the driving tool further comprising:
a prevention member configured to be movable within and out of a moving range of a transfer member arranged in the contact member and configured to have a first position at which the prevention member is positioned within the moving range of the transfer member when the operational force is applied onto the operational member in the second state, and a second position at which the prevention member is positioned out of the moving range of the transfer member when the operational force is released from the operational member in the first state; and
a driving unit configured to allow a state of the prevention member to be switched between the first position and the second position when the operational force is applied onto the operational member,
in a case of selection of the second mode,
when the prevention member is at the first position after the operational force is applied onto the operational member, if the contact member is moved within predetermined time from a moment of the application of the operational force onto the operational member, the driving unit performs release control that brings the prevention member to the second position so that the contact member is in a movable state, and,
when the prevention member is at the first position after the operational force is applied onto the operational member, if time for no movement of the contact member exceeds the predetermined time from the moment of the application of the operational force onto the operational member, the driving unit performs prevention control that maintains the prevention member at the first position so that the contact member is in an unmovable state.
